(19) United States
(12) Patent Application Publication
(10) Pub. No.: US 2023/0354236 A1
(43) Pub. Date: Nov. 2, 2023

(54) COMMUNICATION DEVICE AND COMMUNICATION METHOD

(71) Applicant: Sony Group Corporation, Tokyo (JP)

(72) Inventors: Hiroki MATSUDA, Tokyo (JP); Naoki KUSASHIMA, Tokyo (JP)

(73) Assignee: Sony Group Corporation, Tokyo (JP)

(21) Appl. No.: 18/006,735

(22) PCT Filed: Jul. 26, 2021
(86) PCT No.: PCT/JP2021/027538

§ 371 Date: Jan. 25, 2023

(30) Foreign Application Priority Data
Aug. 5, 2020 (JP) 2020-133411

(51) Int. Cl. H04W 56/00; H04W 74/08

(52) U.S. Cl. CPC H04W 56/005; H04W 74/0833; H04W 84/06

(57) ABSTRACT

A reception unit that receives a timing advance value used for adjusting timing of uplink transmission and correction information for correcting the timing advance value; a determination unit that determines whether or not a predetermined condition regarding application of a correction value that is the timing advance value corrected based on the correction information is satisfied; and a transmission unit that performs, when the predetermined condition is satisfied, uplink transmission other than transmission of a first message in a random access procedure based on the correction value even when a TAT (Time Alignment Timer) that starts in response to reception of the timing advance value does not operate are included.

### FIELD

The present disclosure relates to a communication device and a communication method.

### BACKGROUND

A propagation delay inevitably occurs in communication between a terminal device and a base station. In order to adjust the propagation delay, a communication device such as the terminal device or the base station performs a process called timing advance for adjusting a transmission timing of the communication device.

### CITATION LIST

### Patent Literature

Patent Literature 1: WO 2019/097922 A

### SUMMARY

### Technical Problem

In recent years, with increasing demands for communication performance such as wide area coverage and connection stability, studies on a non-terrestrial network (NTN) in which a wireless network is provided from a device floating in the air or space have started.

In the non-terrestrial network, a base station or a relay station is a non-ground station such as a medium earth orbiting satellite, a low earth orbiting satellite, or an HAPS (High Altitude Platform Station). In this case, there is a possibility that the communication device cannot achieve high communication performance with the conventional timing advance mechanism.

Thus, the present disclosure proposes a communication device and a communication method capable of achieving high communication performance.

The above problem or object is merely one of a plurality of problems or objects that can be solved or achieved by a plurality of embodiments disclosed in the present specification.

### Solution to Problem

In order to solve the above problem, a communication device according to one aspect of the present disclosure includes: a reception unit that receives a timing advance value used for adjusting timing of uplink transmission and correction information for correcting the timing advance value; a determination unit that determines whether or not a predetermined condition regarding application of a correction value that is the timing advance value corrected based on the correction information is satisfied; and a transmission unit that performs, when the predetermined condition is satisfied, uplink transmission other than transmission of a first message in a random access procedure based on the correction value even when a TAT (Time Alignment Timer) that starts in response to reception of the timing advance value does not operate.

### BRIEF DESCRIPTION OF DRAWINGS

FIG. 1 is a diagram illustrating a configuration example of a communication system according to an embodiment of the present disclosure.

FIG. 2 is a diagram illustrating an example of a wireless network provided by the communication system.

FIG. 3 is a diagram illustrating an outline of satellite communication provided by the communication system.

FIG. 4 is a diagram illustrating an example of a cell configured by a non-geostationary satellite.

FIG. 5 is a diagram illustrating a configuration example of a management device according to the embodiment of the present disclosure.

FIG. 6 is a diagram illustrating a configuration example of a ground station according to the embodiment of the present disclosure.

FIG. 7 is a diagram illustrating a configuration example of a satellite station according to the embodiment of the present disclosure.

FIG. 8 is a diagram illustrating a configuration example of a terminal device according to the embodiment of the present disclosure.

FIG. 9 is a diagram for explaining a mechanism of timing advance.

FIG. 10 is a diagram for explaining the mechanism of timing advance.

FIG. 11 is a diagram illustrating an example of uplink synchronization adjustment.

FIG. 12 is a flowchart illustrating an example of initial connection processing.

FIG. 13 is a diagram illustrating a contention-based random access procedure.

FIG. 14 is a diagram illustrating a non-contention-based random access procedure.

FIG. 15 is a diagram illustrating a two-step random access procedure.

FIG. 16 is a sequence diagram illustrating an example of transmission/reception processing (Grant Based).

FIG. 17 is a sequence diagram illustrating an example of transmission/reception processing (Configured Grant).

FIG. 18 is a definition example of a timer regarding timing advance.

FIG. 19A is a diagram illustrating a sequence example in a case where the terminal device updates a TAT (Time Alignment Timer).

FIG. 19B is a diagram illustrating the sequence example in the case where the terminal device updates the TAT (Time Alignment Timer).

FIG. 20A is a diagram illustrating a sequence example in a case where the terminal device uses a timer different from the TAT (Time Alignment Timer).

FIG. 20B is a diagram illustrating the sequence example in the case where the terminal device uses the timer different from the TAT (Time Alignment Timer).

FIG. 21A is a specification change example regarding the timing advance.

FIG. 21B is the specification change example regarding the timing advance.

### DESCRIPTION OF EMBODIMENTS

Hereinafter, embodiments of the present disclosure will be described in detail with reference to the drawings. In each of the following embodiments, the same parts are denoted by the same reference numerals, and redundant description will be omitted.

In the present specification and the drawings, a plurality of constituent elements having substantially the same functional configuration may be distinguished by attaching different numerals after the same reference numerals. For example, the plurality of configurations having substantially the same functional configuration are distinguished as terminal devices 40₁, 40₂, and 40₃ as necessary. However, when it is not particularly necessary to distinguish each of the plurality of constituent elements having substantially the same functional configuration, only the same reference numeral is attached. For example, when it is not particularly necessary to distinguish the terminal devices 40₁, 40₂, and 40₃, the terminal devices are simply referred to as terminal devices 40.

One or more embodiments (including examples and modifications) described below can each be implemented independently. On the other hand, at least some of the plurality of embodiments described below may be appropriately combined with at least some of other embodiments. The plurality of embodiments may include novel features different from each other. Therefore, the plurality of embodiments can contribute to solving different objects or problems, and can exhibit different effects.

The present disclosure will be described according to the following item order.
1. Overview
2. Configuration of communication system
2-1. Overall configuration of communication system
2-2. Configuration of management device
2-3. Configuration of ground station
2-4. Configuration of non-ground station
2-5. Configuration of terminal device
3. Timing advance
3-1. Uplink synchronization adjustment
3-2. Timing advance value expiration date
3-3. Autonomous adjustment of timing advance value
3-4. Problem of autonomous adjustment of timing advance value
4. Basic operation of communication system
4-1. Initial connection processing
4-2. Random access procedure
4-3. Transmission/reception processing (Grant Based)
4-4. Transmission/reception processing (Configured Grant)
5. Processing related to timer related to timing advance
5-1. Overview of processing
5-2. Addition of other processing to conventional timer processing
5-3. Use of new timer different from conventional timer
5-4. Invalidation of conventional timer
5-5. Making conventional timer infinite
5-6. Summary and supplement
5-7. Other processing
6. Sequence example
6-1. Sequence example 1
6-2. Sequence example 2
7. Specification change example
8. Modification
9. Conclusion

### 1. OVERVIEW

Radio access technologies (RAT) such as LTE (Long Term Evolution) and NR (New Radio) have been studied in the 3GPP (3rd Generation Partnership Project). LTE and NR are each a type of cellular communication technology, and a plurality of areas covered by a base station are each arranged in a cell shape to enable mobile communication of a terminal device. At this time, a single base station may manage a plurality of cells.

Note that in the following description, it is assumed that “LTE” includes LTE-A (LTE-Advanced), LTE-A Pro (LTE-Advanced Pro), and EUTRA (Evolved Universal Terrestrial Radio Access). It is also assumed that NR includes NRAT (New Radio Access Technology) and FEUTRA (Further EUTRA). Note that a single base station may manage a plurality of cells. In the following description, a cell corresponding to LTE is referred to as an LTE cell, and a cell corresponding to NR is referred to as an NR cell.

NR is a radio access technology (RAT) of a next generation (fifth generation) of LTE. NR is a radio access technology capable of handling various use cases including eMBB (Enhanced Mobile Broadband), mMTC (Massive Machine Type Communications), and URLLC (Ultra-Reliable and Low Latency Communications). NR is studied for aiming at a technical framework corresponding to use scenarios, required conditions, arrangement scenarios, and the like in these use cases.

Furthermore, in NR, studies of a non-terrestrial network (NTN) have started due to an increase in demand for wide-area coverage, connection stability, and the like. In the non-terrestrial network, a wireless network is planned to be provided for terminal devices via a base station, other than a ground station, such as a satellite station or an aircraft station. The base station other than the ground station is referred to as a non-ground station or a non-ground base station. A wireless network provided by the ground station is referred to as a terrestrial network (TN). By using an identical radio access scheme for the terrestrial network and the non-terrestrial network, an integrated operation of the terrestrial network and the non-terrestrial network is enabled.

When the terminal device transmits data to a base station or a relay station, the terminal device adjusts a transmission timing and transmits the data according to the control of the base station so that the base station side can synchronize a reception timing. This process is called timing advance.

In the non-terrestrial network, a base station or a relay station is a non-ground station such as a medium earth orbiting satellite, a low earth orbiting satellite, or an HAPS (High Altitude Platform Station). The non-ground station moves at a high speed over the sky, and a propagation distance between the non-ground station and the terminal constantly changes. Thus, there is a possibility that a suitable transmission timing is not obtained in a conventional timing advance mechanism. For example, it is assumed that the base station or the relay station is a low earth orbiting satellite. Since the low earth orbiting satellite is moving at an extremely high speed with respect to the terminal device, there is a high possibility that a timing advance value notification of which is provided from the base station will not be a suitable transmission timing assumed by the base station at a timing at which the terminal device transmits data to the base station. In this case, there is a possibility that the non-terrestrial network cannot achieve high communication performance (for example, wide-area coverage, connection stability).

In order to have a suitable transmission timing, it is assumed that the terminal device autonomously adjusts the timing advance value. When the timing advance value can be autonomously adjusted, a suitable timing advance value can be maintained for a long time.

However, a conventional timing advance mechanism includes a timer mechanism for indicating validity of the timing advance value notification of which is provided by the base station. For example, conventional cellular communication includes a TAT (Time Alignment Timer) that starts in response to reception of the timing advance value. Even if the terminal device continues to autonomously update the timing advance value, if the timer expires, the terminal device cannot transmit data. In order to enable the terminal device to continue to autonomously update the timing advance value, the mechanism of the timer needs to be improved.

Thus, in the present embodiment, this problem is solved by the following means.

For example, the terminal device of the present embodiment receives a timing advance value used for adjusting a timing of uplink transmission and correction information for correcting the timing advance value from the base station. Then, the terminal device autonomously corrects the timing advance value based on the correction information.

The terminal device determines whether or not a predetermined condition regarding the application of the corrected timing advance value (hereinafter, referred to as the correction value) is satisfied. For example, when the terminal device itself has capability of performing autonomous correction of the timing advance value and the base station linked with the terminal device itself is a mobile station (for example, low earth orbiting satellite), the terminal device determines that the predetermined condition is satisfied.

When the predetermined condition is satisfied, the terminal device performs the uplink transmission other than transmission of a first message (for example, random access preamble and message A of two-step random access procedure) in a random access procedure based on the correction value even when the TAT is not operating.

As a result, the terminal device can continue to perform uplink transmission based on the autonomously corrected timing advance value even after the timer expires, so that high communication performance (for example, high connection stability) can be achieved.

In some embodiments, an application example to NTN will be described as one of use cases of NR. However, the application destination of these embodiments is not limited to NTN, and the embodiments may be applied to other technologies and use cases (e. g., URLLC).

Although the overview of the present embodiment has been described above, a communication system according to the present embodiment will be described in detail below.

### 2. CONFIGURATION OF COMMUNICATION SYSTEM

A communication system 1 is a cellular communication system using a radio access technology such as LTE or NR, and provides wireless communication via a non-ground station (for example, satellite station or aircraft station) to a terminal device on the ground. If the non-ground station is a satellite station, the communication system 1 may be a Bent-pipe (Transparent) type mobile satellite communication system. The radio access scheme used by the communication system 1 is not limited to LTE and NR, and may be another radio access scheme such as W-CDMA (Wideband Code Division Multiple Access) or cdma 2000 (Code Division Multiple Access 2000).

In the present embodiment, the ground station (also referred to as the ground base station) refers to a base station (including a relay station) installed on the ground. Here, the “ground” means on the ground in a broad sense including not only the ground (land) but also underground, water surface, and underwater. In the following description, the description of “ground station” may be replaced with “gateway”.

The technology of the present disclosure is applicable not only to communication between the non-ground base station and the terminal device but also to communication between the ground base station and the terminal device.

Hereinafter, a configuration of the communication system 1 will be specifically described.

<2-1. Overall Configuration of Communication System>

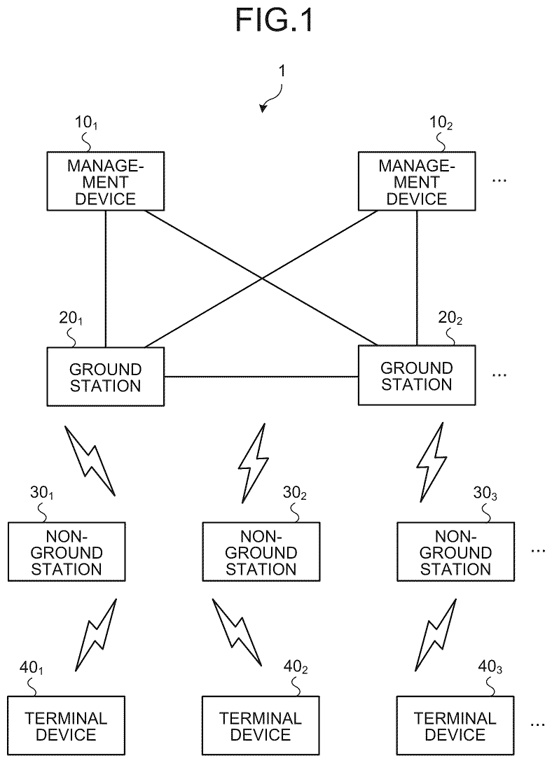

FIG. 1 is a diagram illustrating a configuration example of the communication system 1 according to the embodiment of the present disclosure. The communication system 1 includes a management device 10, a ground station 20, a non-ground station 30, and a terminal device 40. The communication system 1 provides a user with a wireless network that allows mobile communication, by operating each of wireless communication devices constituting the communication system 1 in cooperation with each other. The wireless network of the present embodiment includes, for example, a radio access network and a core network. In the present embodiment, the wireless communication device is a device having a wireless communication function, and corresponds to the ground station 20, the non-ground station 30, and the terminal device 40 in the example of FIG. 1.

The communication system 1 may include a plurality of the management devices 10, a plurality of the ground stations 20, a plurality of the non-ground stations 30, and a plurality of the terminal devices 40. In the example of FIG. 1, the communication system 1 includes management devices 10₁ and 10₂ and the like as the management device 10, and includes ground stations 201 and 20₂ and the like as the ground station 20. In addition, the communication system 1 includes non-ground stations 30₁ and 30₂ and the like as the non-ground station 30, and includes terminal devices 40₁, 40₂, and 40₃ and the like as the terminal device 40.

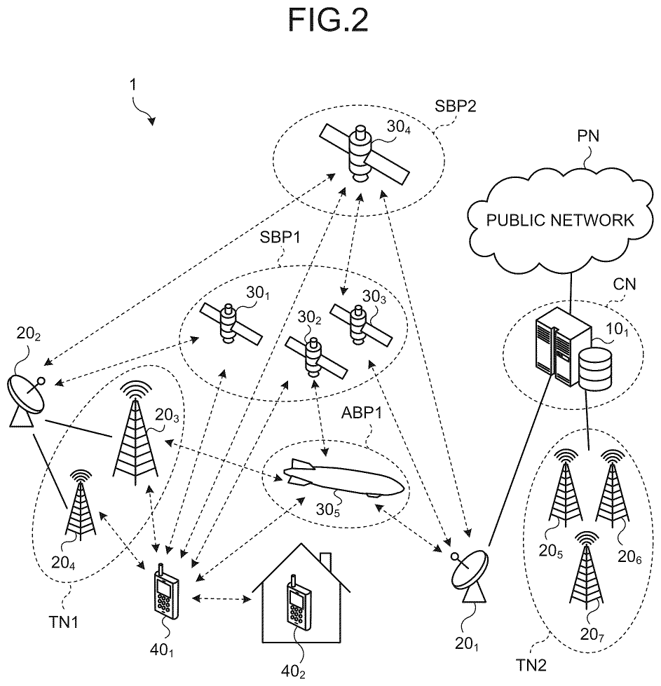

FIG. 2 is a diagram illustrating an example of the wireless network provided by the communication system 1. The ground station 20 and the non-ground station 30 constitute a cell. The cell is an area that covers wireless communication. The cell may be any of a macro cell, a micro cell, a femto cell, and a small cell. The communication system 1 may be configured such that a single base station (satellite station) manages a plurality of cells or a plurality of base stations manage a single cell.

In the example of FIG. 2, ground stations 20₃ and 20₄ constitute a terrestrial network TN1, and ground stations 20₅, 20₆, and 20₇ constitute a terrestrial network TN2. The terrestrial network TN1 and the terrestrial network TN2 are networks operated by, for example, a mobile network operator such as a telephone company. The terrestrial network TN1 and the terrestrial network TN2 may be operated by different mobile network operators or may be operated by the same mobile network operator. The terrestrial network TN1 and the terrestrial network TN2 can be regarded as one terrestrial network.

The terrestrial network TN1 and the terrestrial network TN2 are each connected to a core network. In the example of FIG. 2, the ground station 20 that constitutes the terrestrial network TN2 is connected, for example, to a core network CN constituted by the management device 10₁ and the like. The core network CN is EPC if the radio access scheme of the terrestrial network TN2 is LTE. In addition, the core network CN is 5GC if the radio access scheme of the terrestrial network TN2 is NR. It is a matter of course that the core network CN is not limited to EPC or 5GC, and may be a core network using other radio access schemes. Although the terrestrial network TN1 is not connected to the core network in the example of FIG. 2, the terrestrial network TN1 may be connected to the core network CN. In addition, the terrestrial network TN1 may be connected to a core network (not illustrated) different from the core network CN.

The core network CN is provided with a gateway device, an inter-gateway switch, or the like, and is connected to a public network PN via the gateway device. The public network PN is, for example, a public data network such as the Internet, a regional IP network, a telephone network (such as a mobile telephone network and a fixed telephone network). The gateway device is, for example, a server device connected to the Internet, a regional IP network, or the like. The inter-gateway switch is, for example, a switch connected to a telephone network of a telephone company. The management device 10₁ may have a function as a gateway device or an inter-gateway switch.

Each of the non-ground stations 30 illustrated in FIG. 2 is a non-terrestrial station device such as a satellite station and an aircraft station. A group of satellite stations (or a single satellite station) constituting the non-terrestrial network is called a spaceborne platform. In addition, a group of aircraft stations (or a single aircraft station) constituting the non-terrestrial network is called an airborne platform. In the example of FIG. 2, the non-ground stations 30₁, 30₂, and 30₃ constitute a spaceborne platform SBP1, and the non-ground station 304 constitutes a spaceborne platform SBP2. In addition, the non-ground station 305 constitutes an airborne platform ABP1.

The terminal device 40 can communicate with both the ground station and the non-ground station. In the example of FIG. 2, the terminal device 40₁ can communicate with the ground station that constitutes the terrestrial network TN1. In addition, the terminal device 40₁ can communicate with the non-ground station that constitutes the spaceborne platforms SBP1 and SBP2. In addition, the terminal device 40₁ can also communicate with the non-ground station that constitutes the airborne platform ABP1. The terminal device 40₁ may be capable of directly communicating with another terminal device 40 (the terminal device 40₂ in the example of FIG. 2).

The non-ground station 30 may be capable of being connected to the terrestrial network or the core network via a relay station. The non-ground stations can directly communicate with the other non-ground stations without the intervention of the relay station.

The relay station is, for example, an aviation station or an earth station. The aviation station is a radio station installed on the ground or a mobile body that moves on the ground to communicate with an aircraft station. In addition, the earth station is a radio station located on the earth (including the air) to communicate with a satellite station (space station). The earth station may be a large earth station or a small earth station such as a VSAT (very-small-aperture terminal). The earth station may be a VSAT control earth station (also referred to as a parent station or HUB station) or a VSAT earth station (also referred to as a child station). Further, the earth station may be a radio station installed in a mobile body that moves on the ground. Examples of the earth station mounted on a ship include earth stations on board vessels (ESV). Further, the earth station may include an aircraft earth station, which is installed in an aircraft (including a helicopter) and communicates with a satellite station. Furthermore, the earth station may include an aviation earth station, which is installed in a mobile body that moves on the ground and communicates with an aircraft earth station via a satellite station. The relay station may be a portable and movable radio station that communicates with a satellite station or an aircraft station. The relay station can be considered as a part of the communication system 1.

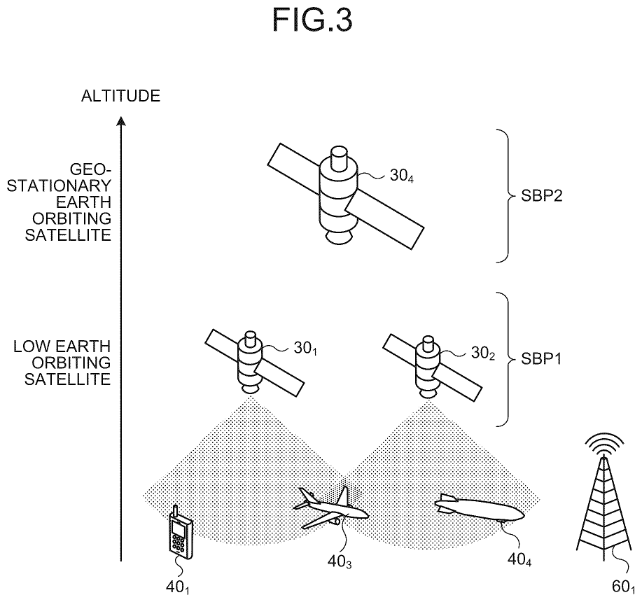

The respective devices constituting the spaceborne platforms SBP1 and SBP2 perform satellite communication with the terminal device 40. The satellite communication refers to wireless communication between a satellite station and a communication device. FIG. 3 is a diagram illustrating an outline of satellite communication provided by the communication system 1. The satellite station is mainly divided into a geostationary earth orbiting satellite station and a low earth orbiting satellite station.

The geostationary earth orbiting satellite station is located at an altitude of approximately 35,786 km and revolves around the earth at the same speed as the earth's rotation speed. In the example of FIG. 3, the non-ground station 304 that constitutes the spaceborne platform SBP2 is a geostationary earth orbiting satellite station. The geostationary earth orbiting satellite station has a relative velocity of approximately zero with the terminal device 40 on the ground and appears stationary when observed from the terminal device 40 on the ground. The non-ground station 304 performs satellite communication with the terminal devices 40₁, 40₃, 40₄, and the like located on the earth.

A low earth orbiting satellite station is a satellite station that orbits at a lower altitude than a geostationary earth orbiting satellite station or a medium earth orbiting satellite station. The low earth orbiting satellite station is, for example, a satellite station located between altitudes of 500 km and 2,000 km. In the example of FIG. 3, the non-ground stations 30₁ and 30₂ that constitute the spaceborne platform SBP1 are low earth orbiting satellite stations. FIG. 3 illustrates only the two non-ground stations 30₁ and 30₂ as satellite stations constituting the spaceborne platform SBP1. In practice, however, in the satellite stations constituting the spaceborne platform SBP1, a low earth orbiting satellite constellation is formed by three or more (e.g. several tens to several thousands) non-ground stations 30. The low earth orbiting satellite station has a relative velocity with respect to the terminal device 40 on the ground unlike the geostationary earth orbiting satellite station and appears to be moving when observed from the terminal device on the ground. The non-ground stations 30₁ and 30₂ each constitute a cell, and perform satellite communication with the terminal devices 40₁, 40₃, 40₄, and the like located on the earth.

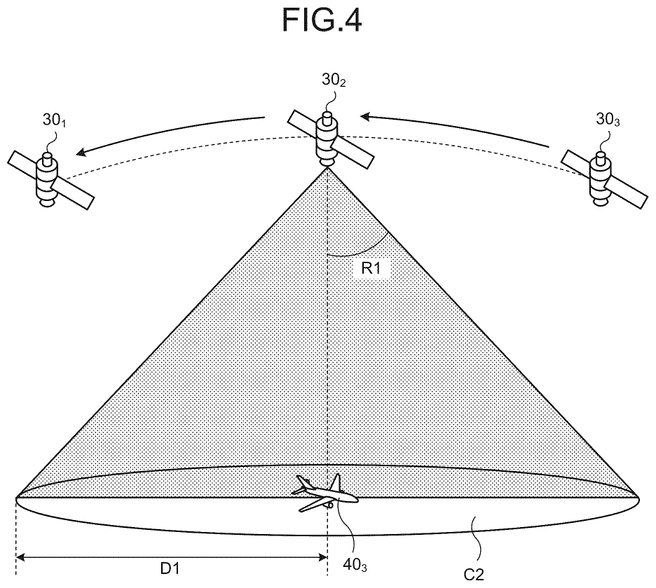

FIG. 4 is a diagram illustrating an example of a cell configured by a non-geostationary satellite. FIG. 4 illustrates a cell C2 formed by the non-ground station 30₂ which is the low earth orbiting satellite station. The satellite station that orbits a low earth orbit communicates with the terminal device 40 on the ground with a predetermined directivity on the ground. For example, an angle R1 illustrated in FIG. 4 is 40°. In the case of FIG. 4, a radius D1 of the cell C2 formed by the non-ground station 30₂ is, for example, 1000 km. The low earth orbiting satellite station moves at a constant speed. In the case where the low earth orbiting satellite station is difficult to provide satellite communication to the terminal device 40 on the ground, the subsequent low earth orbiting satellite station (neighbor satellite station) provides satellite communication. In the case of the example in FIG. 4, when it is difficult for the non-ground station 30₂ to provide satellite communication to the terminal device 40 on the ground, the subsequent non-ground station 30₃ provides satellite communication. The values of the angle R1 and the radius D1 described above are merely examples and are not limited thereto.

As described above, the medium earth orbiting satellite and the low earth orbiting satellite move on the orbit at a very high speed over the sky, and for example, in the case of the low earth orbiting satellite at an altitude of 600 km, the low earth orbiting satellite moves on the orbit at a speed of 7.6 km/S. Although the low earth orbiting satellite forms a cell (or beam) having a radius of several 10 km to several 100 km on the ground, since the cell formed on the ground also moves in accordance with the movement of the satellite, handover may be required even if the terminal device on the ground does not move. For example, assuming a case where the cell formed on the ground has a diameter of 50 km and the terminal device on the ground does not move, handover occurs in about 6 to 7 seconds.

As described above, the terminal device 40 can perform wireless communication using the non-terrestrial network. In addition, the non-ground station 30 of the communication system 1 constitutes the non-terrestrial network. As a result, the communication system 1 can extend the service to the terminal device 40 located in the area that cannot be covered by the terrestrial network. For example, the communication system 1 can provide public safety communication and critical communication for the communication device such as IoT (Internet of Things) devices and MTC (Machine Type Communications) devices. In addition, the use of the non-terrestrial network improves service reliability and recovery, and thus, the communication system 1 can reduce the vulnerability of the service to a physical attack or a natural disaster. In addition, the communication system 1 can implement service connection to aircraft terminal devices such as passengers of airplanes and drones and service connection to mobile terminal devices such as ships and trains. In addition, the communication system 1 can implement the A/V content, group communication, IoT-based broadcast services, software download services, high-performance multicast services such as emergency messages, high-performance broadcast services, and the like. Furthermore, the communication system 1 can support traffic offload between the terrestrial network and the non-terrestrial network. For the implementation described above, it is desirable that the non-terrestrial network provided by the communication system 1 be operationally integrated with the terrestrial network provided by the communication system 1 in a higher layer. In addition, it is desirable that the non-terrestrial network provided by the communication system 1 have a common radio access scheme with the terrestrial network provided by the communication system 1.

The devices in the drawings may be considered as devices in a logical sense. That is, a part of the device in the same drawing may be realized by a virtual machine (VM), a container, a docker, or the like, and they may be implemented on physically the same hardware.

In the present embodiment, the ground station can be rephrased as a base station. The satellite station can be rephrased as a relay station. If the satellite station has a function as a base station, the satellite station can be rephrased as a base station.

The LTE base station is sometimes referred to as an eNodeB (Evolved Node B) or an eNB. In addition, the NR base station is sometimes referred to as a gNodeB or a gNB. In LTE and NR, a terminal device (also referred to as a mobile station or a terminal) is sometimes referred to as UE (User Equipment). The terminal device is a type of communication device and is also referred to as a mobile station or a terminal.

In the present embodiment, the concept of a communication device includes not only portable mobile device (terminal device) such as mobile terminal but also a device installed in a structure or a mobile body. A structure or a mobile body itself may be regarded as a communication device. In addition, the concept of the communication device includes not only a terminal device but also a base station and a relay device. The communication device is a type of processing device and information processing device. Furthermore, the communication device can be rephrased as a transmission device or a reception device.

Hereinafter, a configuration of each device constituting the communication system 1 will be specifically described. The configuration of each device described below is merely an example. The configuration of each device may be different from the following configuration.

<2-2. Configuration of Management Device>

Next, a configuration of the management device 10 will be described.

The management device 10 is a device that manages a wireless network. For example, the management device 10 is a device that manages communication of the ground station 20. If the core network is EPC, the management device 10 is, for example, a device having a function as a MME (Mobility Management Entity). In addition, if the core network is 5GC, the management device 10 is, for example, a device having a function as an AMF (Access and Mobility Management Function) and/or SMF (Session Management Function). It is a matter of course that the functions of the management device 10 are not limited to the MME, the AMF, and the SMF. For example, if the core network is 5GC, the management device 10 may be a device having a function as an NSSF (Network Slice Selection Function), an AUSF (Authentication Server Function), or a UDM (Unified Data Management). Furthermore, the management device 10 may be a device having a function as an HSS (Home Subscriber Server).

The management device 10 may have a function of a gateway. For example, if the core network is EPC, the management device 10 may have a function as an S-GW (Serving Gateway) or a P-GW (Packet Data Network Gateway). Furthermore, if the core network is 5GC, the management device 10 may have a function as a UPF (User Plane Function). The management device 10 is not necessarily a device constituting the core network. For example, it is assumed that the core network is a core network of a W-CDMA (Wideband Code Division Multiple Access) or cdma 2000 (Code Division Multiple Access 2000). In this case, the management device 10 may be a device that functions as a RNC (Radio Network Controller).

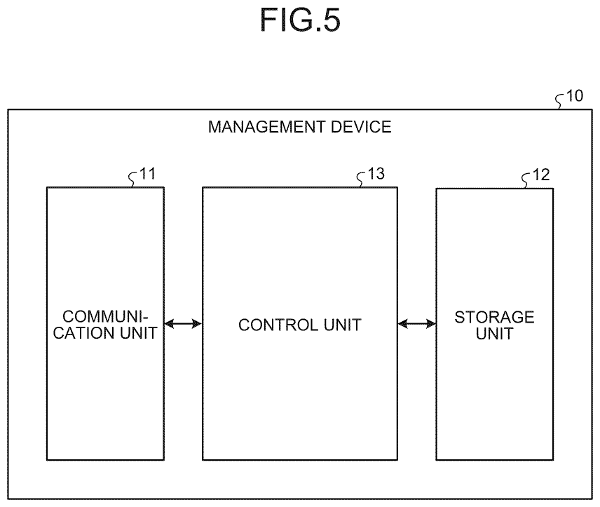

FIG. 5 is a diagram illustrating a configuration example of the management device 10 according to the embodiment of the present disclosure. The management device 10 includes a communication unit 11, a storage unit 12, and a control unit 13. The configuration illustrated in FIG. 5 is a functional configuration, and its hardware configuration may be different from the illustrated one. In addition, functions of the management device 10 may be implemented in the form distributed in a plurality of physically separated components. For example, the management device 10 may include a plurality of server devices.

The communication unit 11 is a communication interface for communicating with other devices. The communication unit 11 may be a network interface or a device connection interface. For example, the communication unit 11 may be a LAN (Local Area Network) interface such as an NIC (Network Interface Card) or may be a USB (Universal Serial Bus) interface including a USB host controller, a USB port, and the like. Furthermore, the communication unit 11 may be a wired interface or a wireless interface. The communication unit 11 functions as communication means of the management device 10. The communication unit 11 communicates with the ground station and the like under the control of the control unit 13.

The storage unit 12 is a data readable/writable storage device, such as a DRAM (Dynamic Random Access Memory), a SRAM (Static Random Access Memory), a flash memory, and a hard disk. The storage unit 12 functions as storage means of the management device 10. The storage unit 12 stores, for example, a connection state of the terminal device 40. For example, the storage unit 12 stores a state of RRC and a state of ECM of the terminal device 40. The storage unit 12 may function as a home memory that stores position information of the terminal device 40.

The control unit 13 is a controller that controls the respective units of the management device 10. The control unit 13 is realized by a processor such as a CPU (Central Processing Unit) and an MPU (Micro Processing Unit). For example, the control unit 13 is realized as the processor executes various programs stored in the storage device inside the management device 10 using a RAM (Random Access Memory) or the like as a work area. The control unit 13 may be realized by an integrated circuit such as an ASIC (Application Specific Integrated Circuit) and an FPGA (Field Programmable Gate Array). All the CPU, MPU, ASIC, and FPGA can be regarded as controllers.

<2-3. Configuration of Ground Station>

Next, a configuration of the ground station 20 will be described.

The ground station 20 is a wireless communication device that wirelessly communicates with the terminal device 40. The ground station 20 may be configured to wirelessly communicate with the terminal device 40 via the non-ground station 30, or may be configured to wirelessly communicate with the terminal device 40 via a relay station on the ground. It is a matter of course that the ground station 20 may be configured to wirelessly communicate directly with the terminal device 40.

The ground station 20 is a type of communication device. More specifically, the ground station 20 is a device corresponding to a radio base station (Base Station, Node B, eNB, gNB, etc.) or a wireless access point (Access Point). The ground station 20 may be a wireless relay station. Further, the ground station 20 may be a light extension device called an RRH (Remote Radio Head). Further, the ground station 20 may be a receiving station such as an FPU (Field Pickup Unit). Furthermore, the ground station 20 may be an LAB (Integrated Access and Backhaul) donor node or an LAB relay node that provides a radio access line and a radio backhaul line by time division multiplexing, frequency division multiplexing, or space division multiplexing.

The radio access technology used by the ground station 20 may be a cellular communication technology or a wireless LAN technology. It is a matter of course that the radio access technology used by the ground station 20 is not limited thereto, and may be another radio access technology. For example, the radio access technology used by the ground station 20 may be an LPWA communication technology. It is a matter of course that the wireless communication used by the ground station 20 may be wireless communication using millimeter waves. Furthermore, the wireless communication used by the ground station 20 may be wireless communication using radio waves or wireless communication (optical wireless) using infrared rays or visible light.

The ground station 20 may be capable of performing NOMA (Non-Orthogonal Multiple Access) communication with the terminal device 40. Here, the NOMA communication is communication using a non-orthogonal resource (transmission, reception, or both). The ground station 20 may be able to perform NOMA communication with another ground station 20.

The ground stations 20 may be able to communicate with each other via a base station-core network interface (for example, S1 Interface or the like). This interface may be either wired or wireless. The base stations may be able to communicate with each other via an inter-base station interface (for example, X2 Interface, S1 Interface, or the like). This interface may be either wired or wireless.

The concept of the base station (also referred to as the base station device) includes not only a donor base station but also a relay base station (relay station or also referred to as the relay station). In addition, the concept of the base station includes not only a structure equipped with functions of the base station but also a device installed in the structure.

The structure is, for example, buildings such as tower buildings, houses, steel towers, railway station facilities, airport facilities, harbor facilities, and stadiums. The concept of the structure includes not only buildings but also non-building structures such as tunnels, bridges, dams, fences, and steel columns, or also includes facilities such as cranes, gates, and windmills. The concept of the structure includes not only structures on the land (ground in a narrow sense) or structures under the ground but also structures on the water such as piers and mega-floats or structures underwater such as ocean observation facilities. The base station can be rephrased as an information processing apparatus.

The ground station 20 may be a donor station or a relay station. Furthermore, the ground station 20 may be a fixed station or a mobile station. The mobile station is a wireless communication device (for example, a base station) configured to be movable. In this case, the ground station may be a device installed in a mobile body or the mobile body itself. For example, a relay station having mobility can be regarded as the ground station 20 as a mobile station. A device that is originally capable of moving, such as a vehicle, a drone, or a smartphone, and has a function of a base station (at least a part of the function of the base station) also corresponds to the ground station as the mobile station.

Here, the mobile body may be a mobile terminal such as a smartphone or a mobile phone. Furthermore, the mobile body may be a mobile body (for example, a vehicle such as an automobile, a bicycle, a bus, a truck, a motorcycle, a train, or a linear motor car) that moves on the land (ground in a narrow sense) or a mobile body that moves under (for example, in a tunnel) the ground (for example, a subway).

In addition, the mobile body may be a mobile body that moves on water (for example, a ship such as a passenger ship, a cargo ship, or a hovercraft), or a mobile body that moves underwater (for example, a submersible ship such as a submersible vessel, a submarine, or an unmanned submarine).

The mobile body may be a mobile body that moves in the atmosphere (for example, an aircraft such as an airplane, an airship, and a drone).

The ground station 20 may be a ground base station (ground station) installed on the ground. For example, the ground station 20 may be a base station placed in a structure on the ground or a base station installed in a mobile body that moves on the ground. More specifically, the ground station 20 may be an antenna installed in a structure such as a building and a signal processing device connected to the antenna. It is a matter of course that the ground station 20 may be a structure or a mobile body itself. The “ground” means on the ground in a broad sense including not only the land (ground in a narrow sense) but also underground, water surface, and underwater. The ground station 20 is not limited to a ground base station. For example, when the communication system 1 is a satellite communication system, the ground station 20 may be an aircraft station. From the perspective of a satellite station, an aircraft station located on the earth is a ground station.

The size of the coverage of the ground station 20 may be large, like macrocells, or may be small, like picocells. It is a matter of course that the size of the coverage of the ground station 20 may be extremely small, like femtocells. The ground station 20 may have a beamforming capability. In this case, the ground station may form a cell or a service area for each beam.

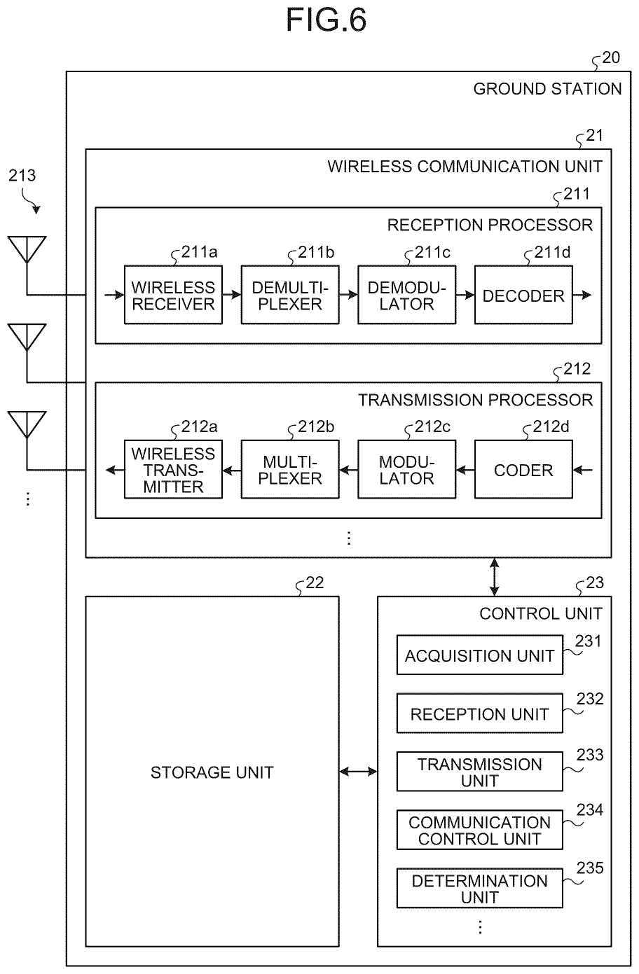

FIG. 6 is a diagram illustrating a configuration example of the ground station 20 according to the embodiment of the present disclosure. The ground station includes a wireless communication unit 21, a storage unit 22, and a control unit 23. The configuration illustrated in FIG. 6 is a functional configuration, and its hardware configuration may be different from the illustrated one. In addition, functions of the ground station 20 may be implemented in the form distributed in a plurality of physically separated components.

The wireless communication unit 21 is a signal processing unit for wirelessly communicating with other wireless communication devices (for example, the terminal device 40). The wireless communication unit 21 operates under the control of the control unit 23. The wireless communication unit 21 supports one or a plurality of radio access schemes. For example, the wireless communication unit 21 supports both NR and LTE. The wireless communication unit 21 may support W-CDMA or cdma2000 in addition to NR and LTE. Furthermore, the wireless communication unit 21 may support an automatic retransmission technology such as HARQ (Hybrid Automatic Repeat reQuest).

The wireless communication unit 21 includes a reception processor 211, a transmission processor 212, and an antenna 213. The wireless communication unit 21 may include a plurality of reception processors 211, transmission processors 212, and antennas 213. The respective units of the wireless communication unit 21 can be configured to support individually for each radio access scheme when the wireless communication unit 21 supports a plurality of radio access schemes. For example, the reception processor 211 and the transmission processor 212 may be configured to support individually for LTE and NR. The antenna 213 may include a plurality of antenna elements (for example, a plurality of patch antennas). In this case, the wireless communication unit 21 may be configured to be beamformable. The wireless communication unit 21 may be configured to enable polarization beamforming using a vertically polarized wave (V-polarized wave) and a horizontally polarized wave (H-polarized wave).

The reception processor 211 processes an uplink signal received via the antenna 213. For example, the reception processor 211 down-converts the uplink signal, removes an unnecessary frequency component, controls an amplification level, performs orthogonal demodulation, performs conversion to a digital signal, removes a guard interval (cyclic prefix), extracts a frequency domain signal using fast Fourier transform, or the like. Then, the reception processor 211 separates an uplink channel, such as a PUSCH (Physical Uplink Shared Channel) and a PUCCH (Physical Uplink Control Channel), and an uplink reference signal from the signals subjected to these processing. Furthermore, the reception processor 211 demodulates a received signal using a modulation scheme such as BPSK (Binary Phase Shift Keying) and QPSK (Quadrature Phase shift Keying) for a modulated symbol of the uplink channel. The modulation scheme used by demodulation may be 16QAM (Quadrature Amplitude Modulation), 64QAM, or 256QAM. In this case, signal points on constellation do not necessarily have to be equidistant. The constellation may be a non uniform constellation (NUC). Then, the reception processor 211 performs decoding processing on demodulated coded bits of the uplink channel. The decoded uplink data and uplink control information are output to the control unit 23.

The transmission processor 212 performs transmission processing of downlink control information and downlink data. For example, the transmission processor 212 encodes the downlink control information and downlink data input from the control unit 23 using an encoding scheme such as block encoding, convolutional encoding, and turbo encoding. Then, the transmission processor 212 modulates the coded bit by using a predetermined modulation scheme such as BPSK, QPSK, 16QAM, 64QAM, and 256QAM. In this case, signal points on constellation do not necessarily have to be equidistant. The constellation may be a non uniform constellation. Then, the transmission processor 212 multiplexes a modulated symbol and a downlink reference signal on each channel and arranges the multiplexed modulated symbol and downlink reference signal in a predetermined resource element. Then, the transmission processor 212 performs various types of signal processing on the multiplexed signal. For example, the transmission processor 212 performs processing such as conversion into the time domain by fast Fourier transform, addition of a guard interval (cyclic prefix), generation of a baseband digital signal, conversion into an analog signal, quadrature modulation, up-conversion, removal of extra frequency components, and power amplification. The signal generated by the transmission processor 212 is transmitted from the antenna 213.

The antenna 213 is an antenna device (antenna unit) that mutually converts a current and a radio wave. The antenna 213 may include one antenna element (for example, one patch antenna) or may include a plurality of antenna elements (for example, a plurality of patch antennas). When the antenna 213 includes the plurality of antenna elements, the wireless communication unit 21 may be configured to be beamformable. For example, the wireless communication unit 21 may be configured to generate a directional beam by controlling the directivity of a wireless signal using a plurality of antenna elements. The antenna 213 may be a dual-polarized antenna. When the antenna 213 is the dual-polarized antenna, the wireless communication unit 21 may use the vertically polarized wave (V-polarized wave) and the horizontally polarized wave (H-polarized wave) in transmitting the wireless signal. Then, the wireless communication unit 21 may control the directivity of the wireless signal transmitted using the vertically polarized wave and the horizontally polarized wave.

The storage unit 22 is a data readable/writable storage device such as a DRAM, an SRAM, a flash memory, and a hard disk. The storage unit 22 functions as a storage means of the ground station 20.

The control unit 23 is a controller that controls the respective units of the ground station 20. The control unit 23 is realized by a processor such as a CPU (Central Processing Unit) and an MPU (Micro Processing Unit). For example, the control unit 23 is realized as the processor executes various programs stored in the storage device inside the ground station 20 using a RAM (Random Access Memory) or the like as a work area. The control unit 23 may be realized by the integrated circuit such as an ASIC (Application Specific Integrated Circuit) and an FPGA (Field Programmable Gate Array). All the CPU, MPU, ASIC, and FPGA can be regarded as controllers.

The control unit 23 includes an acquisition unit 231, a reception unit 232, a transmission unit 233, a communication control unit 234, and a determination unit 235. Each block (the acquisition unit 231 to the determination unit 235) constituting the control unit 23 is a functional block indicating a function of the control unit 23. These functional blocks may be software blocks or hardware blocks. For example, each of the functional blocks described above may be one software module realized by software (including a microprogram), or may be one circuit block on a semiconductor chip (die). It is a matter of course that each functional block may be one processor or one integrated circuit. The control unit 23 may be configured by a functional unit different from the above-described functional block. A configuration method of the functional block is arbitrary.

<2-4. Configuration of Non-Ground Station>

Next, a configuration of the non-ground station 30 will be described.

The non-ground station 30 is a base station that provides the terminal device 40 with a function of a base station. Alternatively, the non-ground station 30 is a relay station that relays communication between the ground station 20 and the terminal device 40. The non-ground station 30 may be a satellite station or an aircraft station.

The satellite station is a satellite station capable of floating outside the atmosphere. The satellite station may be a device mounted on a space vehicle such as an artificial satellite or may be the space vehicle itself. The space vehicle is a moving vehicle that moves outside the atmosphere. Examples of the space vehicle include artificial celestial bodies such as artificial satellites, spacecraft, space stations, and probes.

A satellite serving as the satellite station may be any of a low earth orbiting (LEO) satellite, a medium earth orbiting (MEO) satellite, a geostationary earth orbiting (GEO) satellite, and a highly elliptical orbiting (HEO) satellite. The satellite station can understandably be a device mounted on the low earth orbiting satellite, medium earth orbiting satellite, geostationary earth orbiting satellite, or highly elliptical orbiting satellite.

The aircraft station is a wireless communication device capable of floating in the atmosphere such as an aircraft. The aircraft station may be a device mounted on an aircraft or the like, or may be an aircraft itself. The concept of the aircraft includes not only heavy aircrafts such as airplanes and gliders but also light aircrafts such as balloons and airships. In addition, the concept of the aircraft includes rotorcrafts, such as helicopters and autogyros, in addition to the heavy aircrafts and light aircrafts. The aircraft station (or the aircraft on which the aircraft station is mounted) can be an unmanned aerial vehicle such as a drone.

The concept of the unmanned aerial vehicle also includes unmanned aircraft systems (UAS) and tethered unmanned aerial systems (tethered UAS). In addition, the concept of the unmanned aerial vehicles includes lighter-than-air (LTA) UAS and heavier-than-air (HTA) UAS. In addition, the concept of the unmanned aerial vehicles also includes high-altitude UAS platforms (HAPs).

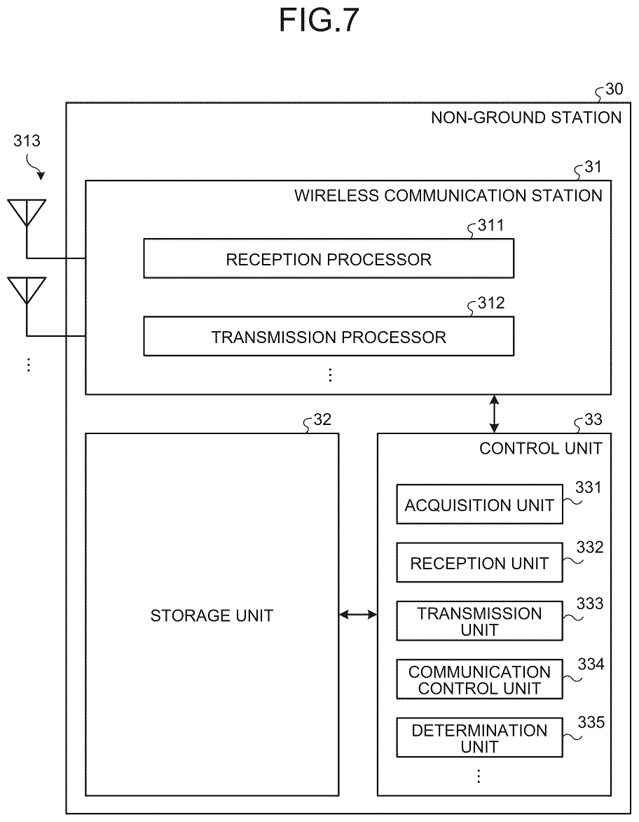

FIG. 7 is a diagram illustrating a configuration example of the non-ground station 30 according to the embodiment of the present disclosure. The non-ground station 30 includes a wireless communication unit 31, a storage unit 32, and a control unit 33. The configuration illustrated in FIG. 7 is a functional configuration, and its hardware configuration may be different from the illustrated one. In addition, functions of the non-ground station 30 may be implemented in the form distributed in a plurality of physically separated components.

The wireless communication unit 31 is a wireless communication interface that wirelessly communicates with other wireless communication devices (for example, the ground station 20, the terminal device 40, and another non-ground station 30). The wireless communication unit 31 supports one or a plurality of radio access schemes. For example, the wireless communication unit 31 supports both NR and LTE. The wireless communication unit 31 may support W-CDMA or cdma3000 in addition to NR and LTE. The wireless communication unit 31 includes a reception processor 311, a transmission processor 312, and an antenna 313. The wireless communication unit 31 may include a plurality of reception processors 311, transmission processors 312, and antennas 313. The respective units of the wireless communication unit 31 can be configured to support individually for each radio access scheme when the wireless communication unit 31 supports a plurality of radio access schemes. For example, the reception processor 311 and the transmission processor 312 may be configured to support individually for LTE and NR. The configurations of the reception processor 311, the transmission processor 312, and the antenna 313 are similar to the configurations of the reception processor 311, the transmission processor 312, and the antenna 313 described above. The wireless communication unit 31 may be configured to be beamformable similarly to the wireless communication unit 21.

The storage unit 32 is a data readable/writable storage device such as a DRAM, an SRAM, a flash memory, and a hard disk. The storage unit 32 functions as a storage means of the non-ground station 30.

The control unit 33 is a controller that controls the respective units of the non-ground station 30. The control unit 33 is realized by, for example, a processor such as a CPU or an MPU. For example, the control unit 33 is realized as the processor executes various programs stored in the storage device inside the non-ground station using a RAM or the like as a work area. The control unit 33 may be realized by an integrated circuit such as an ASIC or an FPGA. All the CPU, MPU, ASIC, and FPGA can be regarded as controllers.

The control unit 33 includes an acquisition unit 331, a reception unit 332, a transmission unit 333, a communication control unit 334, and a determination unit 335. Each block (the acquisition unit 331 to the determination unit 335) constituting the control unit 33 is a functional block indicating a function of the control unit 33. These functional blocks may be software blocks or hardware blocks. For example, each of the functional blocks described above may be one software module realized by software (including a microprogram), or may be one circuit block on a semiconductor chip (die). It is a matter of course that each functional block may be one processor or one integrated circuit. The control unit 33 may be configured by a functional unit different from the above-described functional block. A configuration method of the functional block is arbitrary.

The operation of each block (the acquisition unit 331 to the determination unit 335) of the control unit 33 may be the same as the operation of each block (the acquisition unit 231 to the determination unit 235) of the control unit 23 of the ground station 20. Conversely, the operation of each block (the acquisition unit 231 to the determination unit 235) of the control unit 23 may be the same as the operation of each block (the acquisition unit 331 to the determination unit 335) of the control unit 33 of the non-ground station 30.

As described above, at least one of the ground station 20 and the non-ground station 30 may operate as a base station.

In some embodiments, the concept of the base station may be configured using a set of a plurality of physical or logical devices. For example, the base station in the embodiment of the present disclosure is distinguished into a plurality of devices of a BBU (Baseband Unit) and a RU (Radio Unit), and may be interpreted as an aggregate of these plurality of devices. In addition or instead, in the embodiments of the present disclosure, the base station may be either or both of the BBU and the RU. The BBU and the RU may be connected by a predetermined interface (e.g., eCPRI). In addition or instead, RU may be referred to as Remote Radio Unit (RRU) or Radio DoT (RD). In addition or instead, the RU may support gNB-DU described later. In addition or instead, the BBU may support gNB-CU described later. In addition or instead, the RU may be an apparatus integrally formed with the antenna. An antenna provided in the base station (e.g. the antenna formed integrally with the RU) may adopt an advanced antenna system and support MIMO (e.g. FD-MIMO) or beamforming. In the antenna device in this case, Layer 1 (Physical layer), and the Advanced Antenna System, the antenna (e.g., antenna integrally formed with RU) provided in the base station may include, for example, 64 transmitting antenna ports and 64 receiving antenna ports.

A plurality of base stations may be connected to each other. One or a plurality of base stations may be included in a radio access network (RAN). That is, the base station may be simply referred to as a RAN, a RAN node, an AN (Access Network), or an AN node. The RAN in LTE is referred to as a EUTRAN (Enhanced Universal Terrestrial RAN). The RAN in NR is referred to as NGRAN. The RAN in W-CDMA (UMTS) is referred to as UTRAN. The base station of the LTE is sometimes referred to as an eNodeB (Evolved Node B) or an eNB. That is, the EUTRAN includes one or a plurality of eNodeBs (eNBs). In addition, the NR base station is sometimes referred to as a gNodeB or a gNB. That is, the NGRAN includes one or a plurality of gNBs. In addition, the EUTRAN may include a gNB (en-gNB) connected to a core network (EPC) in an LTE communication system (EPS). Similarly, the NGRAN may include an ng-eNB connected to a core network 5GC in a 5G communication system (5GS). In addition or instead, a case where the base station is an eNB, a gNB, or the like may be referred to as 3GPP Access. In addition or instead, a case where the base station is a radio access point may be referred to as Non-3GPP Access. In addition or instead, the base station may be a light extension device called a RRH (Remote Radio Head). In addition or instead, when the base station is a gNB, the base station may be referred to as a combination of the above-described gNB CU (Central Unit) and gNB DU (Distributed Unit), or any one of the both. The gNB CU (Central Unit) hosts a plurality of higher layers (e.g. RRC, SDAP, and PDCP) of an access stratum for communication with UE. On the other hand, the gNB-DU hosts a plurality of lower layers (e.g. RLC, MAC, and PHY) of the access stratum. That is, among messages and information to be described later, RRC signalling (quasi-static notification) may be generated by the gNB CU, while MAC CE and DCI (dynamic notification) may be generated by the gNB-DU. Alternatively, instead thereof, among RRC configurations (quasi-static notifications), some configurations such as IE: cellGroupConfig may be generated by the gNB-DU, and the remaining configurations may be generated by the gNB-CU. These configurations may be transmitted and received by an F1 interface to be described later. The base station may be configured to be capable of communicating with another base station. For example, when a plurality of base station devices are eNBs or a combination of an eNB and an en-gNB, the base stations may be connected by an X2 interface. In addition or instead, when a plurality of base stations are gNBs or a combination of a gn-eNB and a gNB, the devices may be connected by an Xn interface. In addition or instead, when a plurality of base stations are a combination of a gNB CU (Central Unit) and a gNB DU (Distributed Unit), the devices may be connected by the F1 interface described above. The messages and information (information on RRC signalling, MAC Control Element (MAC CE), or DCI) to be described later may be communicated between the plurality of base stations (for example, via the X2, Xn, or F1 interface).

For example, in some embodiments, the ground station and the non-ground station may both be a combination of gNB or a combination of eNB, or one may be the gNB and the other may be the combination of eNB, or one may be the gNB-CU and the other may be a combination of gNB-DU. That is, when the non-ground station is the gNB and the ground station is the eNB, the gNB of the non-ground station (satellite station) may perform connected mobility (Handover) or dual connectivity by coordination (e.g., X2 signaling, Xn signaling) with the eNB of the ground station. In addition or instead, when the non-ground station is the gNB-DU and the ground station is the gNB-CU, the gNB-DU of the non-ground station (satellite station) may constitute a logical gNB by coordination (e.g., F1 signaling) with the gNB-CU of the ground station.

The cells provided by the base stations are referred to as serving cells. The serving cells include a PCell (Primary Cell) and a SCell (Secondary Cell). When Dual Connectivity (e.g. EUTRA-EUTRA Dual Connectivity, EUTRA-NR Dual Connectivity (ENDC), EUTRA-NR Dual Connectivity with 5GC, NR-EUTRA Dual Connectivity (NEDC), or NR-NR Dual Connectivity) is provided to UE (e.g. the terminal device 40), PCell and zero SCell or one or more SCells provided by an MN (Master Node) are referred to as a master cell group. In addition, the serving cells may include a PSCell (primary secondary cell or primary SCG cell). That is, when Dual Connectivity is provided to the UE, the PSCell provided by an SN (Secondary Node) and zero SCell or one or more SCells are referred to as a secondary cell group (SCG). Unless being specially set (e.g. PUCCH on SCell), a physical uplink control channel (PUCCH) is transmitted by the PCell and the PSCell, but is not transmitted by the SCell. In addition, a radio link failure is also detected in the PCell and the PSCell, but is not detected (is not necessarily detected) in the SCell. The PCell and the PSCell have a special role in the serving cell(s) in this manner, and thus, are also referred to as special cells (SpCells). One downlink component carrier and one uplink component carrier may be associated with one cell. In addition, a system bandwidth corresponding to one cell may be divided into a plurality of bandwidth parts. In this case, one or a plurality of bandwidth parts may be set in UE and one bandwidth part may be used in the UE as an active BWP. In addition, radio resources (for example, a frequency band, numerology (subcarrier spacing), and a slot configuration) that can be used by the terminal device may differ for each cell, each component carrier, or each BWP.

<2-5. Configuration of Terminal Device>

Next, a configuration of the terminal device 40 will be described.

The terminal device 40 is a wireless communication device that wirelessly communicates with the other communication devices such as the ground station 20 and the non-ground station 30. The terminal device 40 is, for example, a mobile phone, a smart device (Smartphone or tablet), a PDA (Personal Digital Assistant), or a personal computer. Further, the terminal device 40 may be a device such as a commercial camera provided with a communication function, or may be a motorcycle, a mobile relay vehicle, or the like equipped with communication equipment such as an FPU (Field Pickup Unit). Furthermore, the terminal device 40 may be an M2M (Machine to Machine) device or an IoT (Internet of Things) device.

The terminal device 40 may be able to perform NOMA communication with the ground station 20. Furthermore, the terminal device 40 may be able to use an automatic retransmission technique such as HARQ when communicating with the ground station 20. The terminal device 40 may be capable of side link communication with another terminal device 40. The terminal device 40 may be able to use an automatic retransmission technique such as HARQ when performing side link communication. The terminal device 40 may also be capable of NOMA communication in communication (side link) with another terminal device 40. In addition, the terminal device 40 may be capable of LPWA communication with another communication device (for example, the ground station 20 and another terminal device 40). The wireless communication used by the terminal device 40 may be wireless communication using millimeter waves. The wireless communication (including side link communication) used by the terminal device 40 may be wireless communication using radio waves or wireless communication using infrared rays or visible light (optical radio).

The terminal device 40 may be a mobile device. The mobile device is a mobile wireless communication device. In this case, the terminal device 40 may be a wireless communication device installed on a mobile body or may be the mobile body itself. For example, the terminal device 40 may be a vehicle moving on a road such as an automobile, a bus, a truck, or a motorcycle, or a wireless communication device mounted on the vehicle. The mobile body may be a mobile terminal, or may be a mobile body that moves on land (ground in a narrow sense), in the ground, on water, or in water. Furthermore, the mobile body may be a mobile body such as a drone or a helicopter that moves in the atmosphere, or a mobile body that moves outside the atmosphere such as an artificial satellite.

The terminal device 40 may connect to a plurality of base station devices or a plurality of cells at the same time to perform communication. For example, when one base station supports a communication area via a plurality of cells (for example, pCell, sCell), it is possible to bundle the plurality of cells and perform communication between the ground stations 20 and the terminal device 40 by carrier aggregation (CA) technology, dual connectivity (DC) technology, and multi-connectivity (MC) technology. Alternatively, the terminal device 40 and the plurality of ground stations 20 can communicate with each other via the cells of the different ground stations 20 by coordinated multi-point transmission and reception (CoMP) technology.

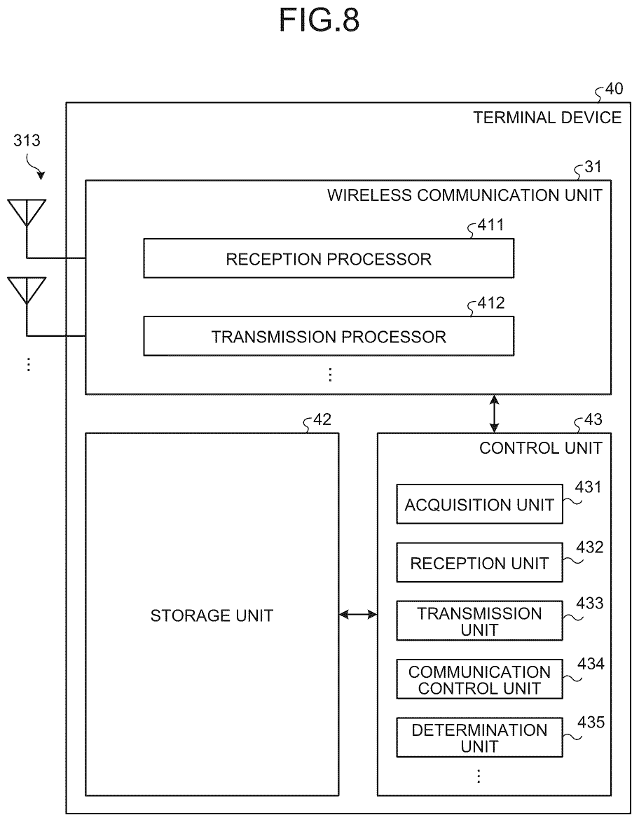

FIG. 8 is a diagram illustrating a configuration example of the terminal device 40 according to the embodiment of the present disclosure. The terminal device includes a wireless communication unit 41, a storage unit 42, and a control unit 43. The configuration illustrated in FIG. 8 is a functional configuration, and its hardware configuration may be different from the illustrated one. In addition, functions of the terminal device 40 may be implemented in the form distributed in a plurality of physically separated components.

The wireless communication unit 41 is a signal processing unit for wirelessly communicating with other wireless communication devices (for example, the ground station 20 and the another terminal device 40). The wireless communication unit 41 operates under the control of the control unit 43. The wireless communication unit 41 includes a reception processor 411, a transmission processor 412, and an antenna 413. The configurations of the wireless communication unit 41, the reception processor 411, the transmission processor 412, and the antenna 413 are similar to the configurations of the wireless communication unit 21, the reception processor 211, the transmission processor 212, and the antenna 213 of the ground station 20. The wireless communication unit 41 may be configured to be beamformable similarly to the wireless communication unit 21.

The storage unit 42 is a data readable/writable storage device such as a DRAM, an SRAM, a flash memory, and a hard disk. The storage unit 42 functions as storage means of the terminal device 40.

The control unit 43 is a controller that controls the respective units of the terminal device 40. The control unit 43 is realized by, for example, a processor such as a CPU or an MPU. For example, the control unit 43 is realized as the processor executes various programs stored in the storage device inside the terminal device 40 using a RAM or the like as a work area. The control unit 43 may be realized by an integrated circuit such as an ASIC or an FPGA. All the CPU, MPU, ASIC, and FPGA can be regarded as controllers.

The control unit 43 includes an acquisition unit 431, a reception unit 432, a transmission unit 433, a communication control unit 434, and a determination unit 435. Each block (the acquisition unit 431 to the determination unit 435) constituting the control unit 43 is a functional block indicating a function of the control unit 43. These functional blocks may be software blocks or hardware blocks. For example, each of the functional blocks described above may be one software module realized by software (including a microprogram), or may be one circuit block on a semiconductor chip (die). It is a matter of course that each functional block may be one processor or one integrated circuit. The control unit 43 may be configured by a functional unit different from the above-described functional block. A configuration method of the functional block is arbitrary.

### 3. TIMING ADVANCE

The configuration of the communication system 1 has been described above. Next, the timing advance will be described.

<3-1. Uplink Synchronization Adjustment>

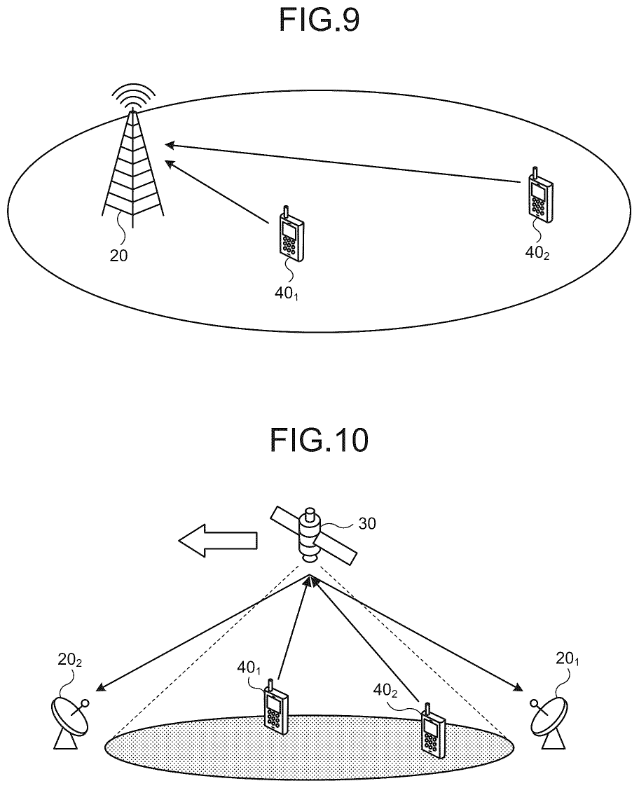

The uplink signals are preferably received at the same timing. Thus, the timing is adjusted in consideration of a propagation delay difference. FIGS. 9 and 10 are diagrams for explaining the mechanism of timing advance. For example, as illustrated in FIG. 9, it is assumed that the terminal device 40₁ located near the ground station 20 and the terminal device 40₂ located far from the ground station simultaneously perform uplink communication. In the example of FIG. 9, the ground station 20 is a base station.

In this environment, it is assumed that the plurality of terminal devices 40 have transmitted the uplink based on a downlink synchronization timing. In this case, a transmission signal of the terminal device 40 is received at different timings in the base station due to different propagation delays, a processing delay specific to the terminal device, and the like. The same applies to the satellite communication system as illustrated in FIG. 10. In the case of FIG. 10, the base station that receives the uplink signal may be the non-ground station 30 or the ground station 20. When the uplink channel/signal reception timings are different, intersymbol interference occurs, and characteristics are degraded.

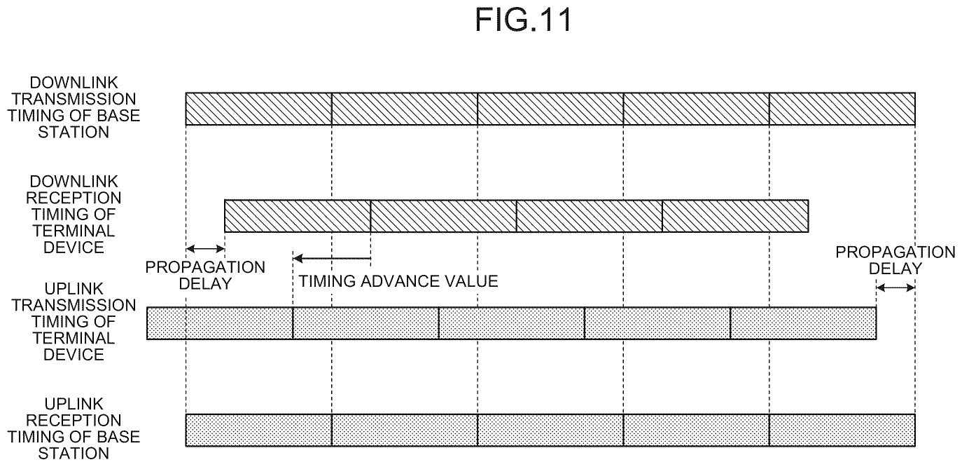

Thus, the terminal device 40 and the base station adjust the uplink transmission timing of the terminal device 40 so that the downlink transmission timing and the uplink reception timing match. FIG. 11 is a diagram illustrating an example of uplink synchronization adjustment. Assuming that the downlink transmission timing of the base station is set as illustrated in FIG. 11, the downlink physical channel/signal is received by the terminal device 40 with a predetermined time delay due to influences of a propagation delay, a processing delay of the terminal device 40, and the like.

Thus, the terminal device 40 adjusts the uplink transmission timing using the timing advance value instructed from the base station with reference to the timing at which the downlink physical channel/signal is received. As a result, the adjusted uplink physical channel/signal is received by the base station at the same timing. This mechanism is called timing advance.

The timing advance value is calculated as approximately twice a one-way delay time. The timing advance value is a value unique to the terminal device, and is provided in notification for each terminal device. PRACH can be used to calculate the timing advance value. For example, a random access response (RAR) or MAC CE (Control Element) is used to provide notification of the timing advance value.

<3-2. Expiration of Timing Advance Value>

The timing advance value has an expiration. The terminal device 40 starts or restarts a timer (for example, time alignment timer) at the timing of receiving the timing advance value from the base station device. Then, the terminal device 40 executes the uplink transmission assuming that the timing advance value is correct until the timer expires.

On the other hand, when the timer expires or does not start, the terminal device 40 can execute only the transmission of the first message in the random access procedure. At this time, the terminal device 40 may recognize that the timing advance value is an invalid value. Here, the first message in the random access procedure is the transmission of the random access preamble or Message A in the two-step random access procedure. That is, when the timer is not valid, the terminal device 40 cannot perform uplink data transmission other than the transmission of the first message in the random access procedure.

<3-3. Autonomous Adjustment of Timing Advance Value>

It is assumed that the base station or the relay station is the non-ground station 30 such as a medium earth orbiting satellite, a low earth orbiting satellite, or an HAPS (High Altitude Platform Station). The non-ground station 30 moves at a high speed over the sky, and a propagation distance between the non-ground station 30 and the terminal device 40 constantly changes. Thus, the transmission timing of the uplink signal may not be a suitable timing in the conventional timing advance mechanism.

For example, it is assumed that the non-ground station 30 is a low earth orbiting satellite. Since the low earth orbiting satellite is moving at an extremely high speed with respect to the terminal device 40, there is a high possibility that the timing advance value will not be a suitable value assumed by the base station at a timing at which the terminal device 40 transmits data to the base station. In this case, the terminal device 40 cannot transmit a signal at a suitable transmission timing.

In order to have a suitable transmission timing, it is assumed that the terminal device 40 autonomously adjusts the timing advance value. For example, the terminal device 40 receives correction information necessary for correcting (that is, autonomously adjusting) the timing advance value from the base station, and continues to correct the timing advance value to a suitable value based on the received correction information. When the timing advance value is autonomously adjusted, the terminal device 40 can maintain a suitable timing advance value for a long time.

<3-4. Problem of Autonomous Adjustment of Timing Advance Value>

However, as described above, the conventional timing advance mechanism includes a timer that determines the expiration of the timing advance value. Even if the terminal device 40 continues to autonomously correct the timing advance value, if the timer expires, the terminal device 40 cannot transmit data to the base station. In order to enable the terminal device 40 to continue to autonomously correct the timing advance value, the mechanism of the timer needs to be improved.

### 4. BASIC OPERATION OF COMMUNICATION SYSTEM

Although the problem of the autonomous adjustment of the timing advance value has been described above, a basic operation of the communication system 1 will be described before describing the operation of the communication system 1 that solves the problem.

In the following description, the ground station can be read as a base station or a gateway. Furthermore, the ground station 20 may be replaced with the non-ground station 30.

<4-1. Initial Connection Processing>

First, initial connection processing will be described.

The initial connection processing is processing for transitioning a wireless connection state of the terminal device 40 from an unconnected state to a connected state. The unconnected state is, for example, RRC_IDLE or RRC INACTIVE. RRC_IDLE is an idle state in which the terminal device is not connected to any cell, and is also referred to as an idle mode. RRC INACTIVE is a radio connection state indicating an inactive state newly defined in NR, and is also referred to as an inactive mode. In RRC INACTIVE, RRC connection itself is not established between the terminal device 40 and the base station; however, for some UE contexts, the terminal device 40 and the base station may keep holding each other. The terminal device 40 and the base station may use the held UE context to speed up the transition of the terminal device 40 to the connected state again. The unconnected state may include a lightning mode. The connected state is, for example, RRC_CONNECTED. RRC_CONNECTED is a connected state in which the terminal device establishes a connection with a specific cell (e.g., Primary Cell), and is also referred to as a connected mode.

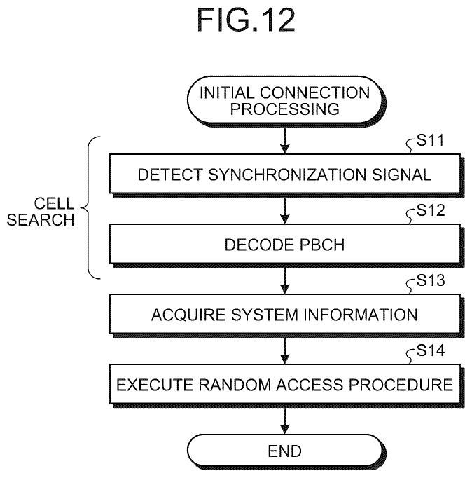

FIG. 12 is a flowchart illustrating an example of the initial connection processing. The initial connection processing will be described below with reference to FIG. 12. The initial connection processing described below is executed, for example, when the terminal device 40 is powered on.

If the communication system 1 is a Bent-pipe type mobile satellite communication system, the base station is the ground station 20. In this case, the following processing is executed between the terminal device 40 and the ground station 20 via the non-ground station 30. It is a matter of course that the base station may be the non-ground station 30. In this case, the following processing is executed between the terminal device 40 and the non-ground station 30. In the following description, it is assumed that the base station is the ground station 20; however, the description of the ground station 20 can be appropriately replaced with the non-ground station 30.

First, the terminal device 40 in the unconnected state performs cell search. The cell search is a procedure for UE (User Equipment) to detect a PCI (Physical Cell ID) of a cell and obtain time and frequency synchronization. The cell search of the present embodiment includes a step of detecting a synchronization signal and decoding a PBCH (Physical Broadcast Channel). The reception unit 432 of the terminal device 40 detects a cell synchronization signal (Step S11).

The reception unit 432 performs synchronization in the downlink with the cell based on the detected synchronization signal. Then, after the downlink synchronization is established, the reception unit 432 attempts to decode the PBCH and acquires an MIB (Master Information Block) that is a part of the system information (Step S12).

The System information is information for informing a setting in a cell that transmits the system information. The system information may be information common to all the terminal devices (including the terminal device 40) belonging to the cell. The system information may be information specific to the cell. The system information includes, for example, information related to access to the cell, information related to cell selection, information related to another RAT and another system, and the like. The system information includes an MIB and an SIB (System Information Block). The MIB is information necessary for receiving the SIB and the like, and is information of a fixed payload-size broadcast by PBCH. The MIB includes a part of a system frame number, information of at least an SIB 1 and a Msg.2/4 for an initial connection and information of a subcarrier interval of pagings and a broadcast SI messages, information of a subcarrier offset, information of a DMRS type A position, PDCCH settings for at least the SIB 1, information of cell prohibition (cell barred), information of intra-frequency reselection, and the like. The SIB is system information other than the MIB and is broadcast by the PDSCH.

The system information can be classified into first system information, second system information, and third system information. The first system information and the second system information include information related to access to the cell, information related to acquisition of other system information, and information related to cell selection. Information included in the MIB is the first system information. The information included in the SIB 1 in the SIB is the second system information (e.g., Remaining Minimum SI). The remaining system information is the third system information (e.g., Other SI).

Also in NR, the system information is broadcast from the NR cell. A physical channel carrying the system information may be transmitted in a slot or a mini-slot. The mini-slot is defined by the number of symbols smaller than the number of symbols of the slot. By transmitting the physical channel carrying the system information in the mini-slot, it is possible to decrease the time necessary for beam sweeping and to reduce the overhead. In the case of NR, the first system information is transmitted in NR-PBCH, and the second system information is transmitted in a physical channel different from NR-PBCH.

The acquisition unit 431 of the terminal device acquires the second system information based on the MIB (that is, the first system information) (Step S13). As described above, the second system information includes SIB1 and SIB2.

SIB1 is scheduling information of system information other than the access control information and SIB1 of the cell. In the case of NR, the SIB1 includes information related to a cell selection (for example, cellSelectionInfo), information related to a cell access (for example, cellAccessRelatedInfo), information related to connection establishment failure control (for example, connEstFailureControl), scheduling information of system information other than the SIB 1 (for example, si-SchedulingInfo), settings of a serving cell, and the like. The settings of the serving cell include a cell-specific parameter, and include downlink settings, uplink settings, TDD setting information, and the like. The uplink settings include an RACH setting and the like. In the case of LTE, the SIB1 includes access information of the cell, cell selection information, the maximum uplink transmission power information, TDD setting information, cycle of the system information, mapping information of the system information, a length of an SI (System Information) window, and the like.

In the case of NR, the SIB2 includes cell reselection information (for example, cellReselectionInfoCommon) and cell reselection serving frequency information (for example, cellReselectionServingFreqInfo). In the case of LTE, the SIB2 includes connection prohibition information, cell-common radio resource setting information (radioResourceConfigCommon), uplink carrier information, and the like. The cell-common radio resource setting information includes cell-common PRACH (Physical Random Access Channel) and RACH (Random Access Channel) setting information.

When the acquisition unit 431 has not been able to acquire the system information necessary for establishing the link, the control unit 43 of the terminal device 40 determines that access to the cell is prohibited. For example, when the first system information cannot be acquired, the control unit 43 determines that access to the cell is prohibited. In this case, the control unit 43 ends the initial connection processing.

When the system information can be acquired, the control unit 43 executes a random access procedure based on the first system information and/or the second system information (Step S14). The random access procedure may be referred to as an RACH (Random Access Channel Procedure) procedure or an RA procedure. Upon completion of the random access procedure, the terminal device 40 transitions from the unconnected state to the connected state.

<4-2. Random Access Procedure>

Next, a random access procedure will be described.

The random access procedure is performed for the purpose of “RRC connection setup” from the idle state to the connected state (or the inactive state), “request for state transition” from the inactive state to the connected state, and the like. The random access procedure is also used for the purpose of “scheduling request” for making a resource request for uplink data transmission and “timing advance adjustment” for adjusting uplink synchronization. In addition, the random access procedure is performed in the case of “on-demand SI request” for requesting the system information that is not transmitted, “beam recovery” for recovering interrupted beam connection, “handover” for switching a connected cell, and the like.

The “RRC connection setup” is an operation executed when the terminal device 40 connects to the ground station 20 in accordance with the occurrence of traffic or the like. The “RRC connection setup” is specifically an operation to deliver information on connection (for example, UE context) from the ground station 20 to the terminal device 40. The UE context is managed by certain communication device identification information (for example, C-RNTI) instructed from the ground station 20. The terminal device 40, upon end of this operation, state-transitions from the idle state to the non-active state or from the idle state to the connected state.

The “request for state transition” is an operation to make a request for state transition from the non-active state to the connected state in accordance with the occurrence of traffic or the like by the terminal device 40. Transitioning to the connected state, the terminal device 40 can transmit and receive unicast data to and from the ground station 20.

The “scheduling request” is an operation to make a resource request for uplink data transmission in accordance with the occurrence of traffic or the like by the terminal device 40. The ground station 20, upon normal reception of this scheduling request, assigns a PUSCH resource to the communication device. The scheduling request is also performed by the PUCCH.

The “timing advance adjustment” is an operation for adjusting a frame error between the downlink and the uplink caused by a transmission delay. The terminal device transmits the PRACH (Physical Random Access Channel) with timing adjusted to a downlink frame. Thus, the ground station 20 can recognize the transmission delay with respect to the terminal device 40 and can instruct the timing advance value to the terminal device 40 by Message 2 or the like.

The “on-demand SI request” is an operation to make a request for transmission of the system information to the ground station 20 when the system information that has not been transmitted for the purpose of the overhead of the system information or the like is necessary for the terminal device 40.

The “beam recovery” is an operation to make a recovery request when communication quality degrades by movement of the terminal device 40, interruption of a communication route by another object, or the like after a beam is established. The ground station 20 that has received this request attempts connection with the terminal device 40 using a different beam.

The “handover” is an operation to switch connection from a connected cell (a serving cell) to a cell adjacent to the cell (a neighbor cell) by a change in a radio wave environment or the like by movement of the terminal device 40 or the like. The terminal device 40 that has received a handover command from the ground station 20 makes a connection request to the neighbor cell designated by the handover command.

The random access procedure includes a contention based random access procedure and a non-contention based random access procedure. First, the contention based random access procedure will be described.

The random access procedure described below is a random access procedure assuming that RAT supported by the communication system 1 is LTE. However, the random access procedure described below is also applicable to a case where the RAT supported by the communication system 1 is other than the LTE.

(Contention-Based Random Access Procedure)

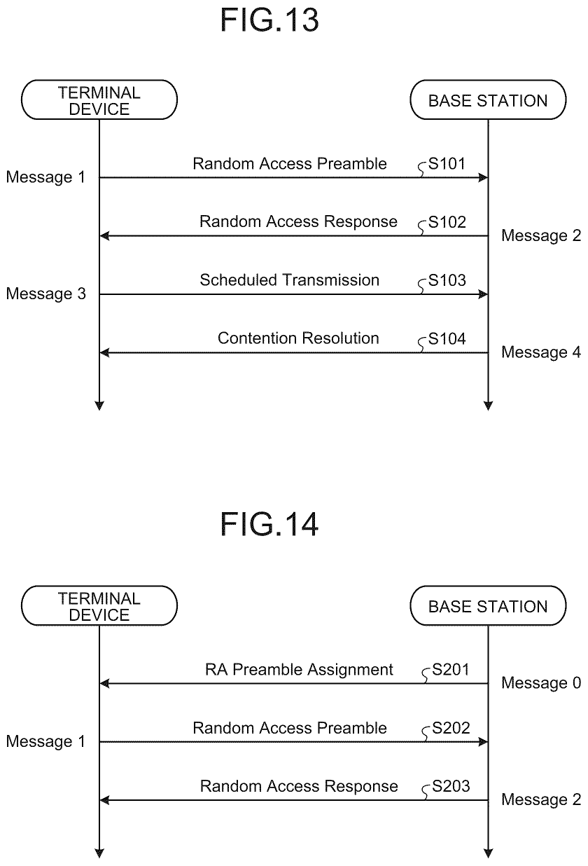

The contention-based random access procedure is a random access procedure performed under the initiative of the terminal device 40. FIG. 13 is a diagram illustrating the contention-based random access procedure. As illustrated in FIG. 13, the contention-based random access procedure is a four-step procedure starting from the transmission of the random access preamble from the terminal device 40. The contention-based random access procedure includes processes of transmission of the random access preamble (Message 1), reception of a random access response (Message 2), transmission of a message (Message 3), and reception of a contention resolution message (Message 4).

First, the terminal device 40 randomly selects a preamble sequence to be used out of a plurality of preamble sequences set in advance. The terminal device 40 then transmits a message including the selected preamble sequence (Message 1: Random Access Preamble) to the connected ground station 20 (Step S101). The random access preamble is transmitted by the PRACH.

The control unit 23 of the ground station 20, upon reception of the random access preamble, transmits the random access response (Message 2: Random Access Response) thereto to the terminal device 40. This random access response is transmitted using the PDSCH, for example. The terminal device 40 receives the random access response (Message 2) transmitted from the ground station 20 (Step S202). The random access response includes one or a plurality of random access preambles that have been able to be received by the ground station 20 and a UL (Up Link) resource (hereinafter, referred to as uplink grant) corresponding to the random access preambles. The random access response further includes a TC-RNTI (Temporary Cell Radio Network Temporary Identifier) as an identifier unique to the terminal device 40 that the ground station 20 has temporarily assigned to the terminal device 40.

The terminal device 40, upon reception of the random access response from the ground station 20, determines whether the reception information includes the random access preamble transmitted at Step S101. If the random access preamble is included, the terminal device 40 extracts the uplink grant corresponding to the random access preamble transmitted at Step S101 out of the uplink grant included in the random access response. The terminal device 40 then transmits a UL message (Message 3: Scheduled Transmission) using a resource scheduled by the extracted uplink grant (Step S103). Transmission of the message (Message 3) is performed using the PUSCH. The message (Message 3) includes an RRC (Radio Resource Control) message for a RRC connection request. The message (Message 3) further includes an identifier of the terminal device 40. The message (Message 3) may be described as “Msg3”.

In the contention-based random access procedure, a random access preamble randomly selected by the terminal device 40 is used for the procedure. Thus, a case can occur in which the terminal device 40 transmits the random access preamble, and at the same time, another terminal device 40 transmits the same random access preamble to the ground station 20. Given these circumstances, the control unit 23 of the ground station 20 receives the identifier transmitted by the terminal device 40 at Step S103, thereby recognizes with which the terminal device preamble contention has occurred, and performs contention resolution. The control unit 23 transmits contention resolution (Message 4: Contention Resolution) to the terminal device 40 selected by the contention resolution. The contention resolution (Message 4) includes the identifier transmitted by the terminal device 40 at Step S103. The contention resolution (Message 4) further includes an RRC message of RRC connection setup. The terminal device 40 receives the contention resolution message (Message 4) transmitted from the ground station 20 (Step S104).

The terminal device 40 compares the identifier transmitted at Step S103 and the identifier received at Step S104 with each other. When the identifiers do not match, the terminal device 40 again performs the random access procedure from Step S101. When the identifiers match, the terminal device 40 performs an RRC connection operation to transition from the idle state (RRC_IDLE) to the connected state (RRC_CONNECTED). The terminal device uses the TC-RNTI acquired in Step S102 as a C-RNTI (Cell Radio Network Temporary Identifier) in subsequent communication. After transitioning to the connected state, the terminal device 40 transmits an RRC message indicating RRC connection setup completion to the ground station 20. The RRC connection setup complete message is also referred to as Message 5. Through this series of operations, the terminal device 40 is connected to the ground station 20.

The contention-based random access procedure illustrated in FIG. 13 is a four-step random access procedure (4-step RACH). However, the communication system 1 can also support a two-step random access procedure (2-step RACH) as the contention-based random access procedure. For example, the terminal device 40 transmits the random access preamble and also transmits the message (Message 3) described in Step S103. Then, the control unit 23 of the ground station 20 transmits the random access response (Message 2) and the contention resolution (Message 4) as the responses. Since the random access procedure is completed in two steps, the terminal device 40 can be quickly connected to the ground station 20.

(Non-Contention-Based Random Access Procedure)

Next, the non-contention based random access procedure will be described. The non-contention-based random access procedure is a random access procedure performed under the initiative of the base station. FIG. 14 is a diagram illustrating the non-contention-based random access procedure. The non-contention-based random access procedure is a three-step procedure starting from the transmission of the random access preamble assignment from the ground station 20. The non-contention-based random access procedure includes processes of reception of the random access preamble assignment (Message 0), transmission of the random access preamble (Message 1), and reception of the random access response (Message 2).

In the contention-based random access procedure, the terminal device 40 randomly selects the preamble sequence. However, in the non-contention based random access procedure, the ground station 20 assigns an individual random access preamble to the terminal device 40. The terminal device 40 receives the random access preamble assignment (Message 0: RA Preamble Assignment) from the ground station 20 (Step S201).

The terminal device 40 performs random access to the ground station 20 using the random access preamble assigned in Step S301. That is, the terminal device 40 transmits a message including the assigned random access preamble (Message 1: Random Access Preamble) to the ground station 20 by the PRACH (Step S202).

The control unit 23 of the ground station 20 receives the random access preamble (Message 1) from the terminal device 40. Then, the control unit 23 transmits the random access response (Message 2: Random Access Response) to the random access preamble to the terminal device 40 (Step S303). The random access response includes, for example, information of the uplink grant corresponding to the received random access preamble. When receiving the random access response (Message 2), the terminal device 40 performs the RRC connection operation to transition from the idle state (RRC_IDLE) to the connected state (RRC_CONNECTED).

As described above, in the non-contention-based random access procedure, since the ground station 20 schedules the random access preamble, collision of the preamble hardly occurs.

(Details of Random Access Procedure of NR)

The random access procedure assuming that the RAT supported by the communication system 1 is the LTE has been described above. The above random access procedure is also applicable to the RAT other than the LTE. Hereinafter, the random access procedure assuming that the RAT supported by the communication system 1 is NR will be described in detail. In the following description, four steps related to Message 1 to Message 4 illustrated in FIG. 13 or 14 will be described in detail. The step of Message 1 corresponds to Step S101 illustrated in FIG. 13 and Step S202 illustrated in FIG. 14. The step of Message 2 corresponds to Step S102 illustrated in FIG. 13 and Step S203 illustrated in FIG. 14. The step of Message 3 corresponds to Step S103 illustrated in FIG. 13. The step of Message 4 corresponds to Step S104 illustrated in FIG. 13.

Random access preamble of NR (Message 1) In the NR, the PRACH is called NR-PRACH (NR Physical Random Access Channel). The NR-PRACH is formed using the Zadoff-Chu sequence. In the NR, a plurality of preamble formats are defined as a format of the NR-PRACH. The preamble formats are prescribed by a combination of parameters such as a subcarrier interval of the PRACH, a transmission band width, a sequence length, a symbol number for use in transmission, a transmission repeated number, a CP (Cyclic Prefix) length, and a guard period length. The type of the preamble sequence of the NR-PRACH is numbered. The number of the type of the preamble sequence is referred to as a preamble index.

In the NR, setting regarding the NR-PRACH is performed on the terminal device 40 in the idle state by the system information. In addition, setting regarding the NR-PRACH is performed on the terminal device 40 in the connected state by dedicated RRC signaling.

The terminal device 40 transmits the NR-PRACH using a physical resource (NR-PRACH occasion) that can be transmitted by the NR-PRACH. The physical resource is indicated by a setting related to the NR-PRACH. The terminal device 40 selects one of the physical resources and transmits the NR-PRACH. In addition, when the terminal device 40 is in the connected state, the terminal device 40 transmits the NR-PRACH using the NR-PRACH resource. The NR-PRACH resource is a combination of an NR-PRACH preamble and a physical resource thereof. The ground station 20 can instruct the NR-PRACH resource to the terminal device 40.

The NR-PRACH is also transmitted when the random access procedure fails. The terminal device 40, when resending the NR-PRACH, waits for transmission of the NR-PRACH for a waiting period calculated from the value of back off (a back off indicator: BI). The backoff values may differ depending on the terminal categories of the terminal device 40 and priorities of traffics generated. At this time, notification of a plurality of backoff values are provided, and the terminal device 40 selects a backoff value to be used according to the priorities. When retransmitting NR-PRACH, the terminal device 40 increases the transmission power of NR-PRACH compared with the initial transmission. This procedure is referred to as power ramping.

Random Access Response of NR (Message 2)

The random access response of NR is transmitted using NR-PDSCH (NR Physical Downlink Shared Channel). The NR-PDSCH including the random access response is scheduled by the NR-PDCCH (NR Physical Downlink Control Channel) with the CRC (Cyclic Redundancy Check) scrambled by the RA-RNTI. The NR-PDCCH is transmitted by CORESET (Control Resource Set). The NR-PDCCH with the CRC scrambled by the RA-RNTI is placed in CSS (Common Search Space) of a Type1-PDCCH CSS set. The value of the RA-RNTI (Random Access Radio Network Temporary Identifier) is determined based on a transmission resource of the NR-PRACH corresponding to the random access response. The transmission resource of the NR-PRACH is a time resource (a slot or a subframe) and a frequency resource (a resource block), for example. The NR-PDCCH may be placed in a search space associated with the NR-PRACH associated with the random access response. Specifically, the search space in which the NR-PDCCH is placed is set in association with the physical resource by which the preamble of the NR-PRACH and/or the NR-PRACH has been transmitted. The search space in which the NR-PDCCH is placed is set in association with the preamble index and/or an index of the physical resource. The NR-PDCCH is NR-SS (NR Synchronization signal) and QCL (Quasi co-location).

The random access response of NR is information of MAC (Medium Access Control). The random access response of NR includes at least an uplink grant for transmitting Message 3 of NR, a value of a timing advance used for adjusting uplink frame synchronization, and a value of a TC-RNTI. Further, the random access response of NR includes a PRACH index used to transmit the NR-PRACH corresponding to the random access response. Further, the random access response of NR includes information related to backoff used for waiting for PRACH to be transmitted.

The control unit 23 of the ground station 20 transmits the random access response by the NR-PDSCH. The terminal device 40 determines whether transmission of the random access preamble has succeeded from the information included in the random access response. When it is determined that transmission of the random access preamble has failed, the terminal device 40 performs processing to transmit Message 3 of NR in accordance with the information included in the random access response. On the other hand, when transmission of the random access preamble has failed, the terminal device 40 determines that the random access procedure has failed and performs processing to resend the NR-PRACH.

The random access response of NR may include a plurality of uplink grants for transmitting Message 3 of NR. The terminal device 40 can select one resource transmitting Message 3 from the plurality of uplink grants. Thus, a collision of the Message 3 transmission of NR when the same random access response of NR is received by the different terminal devices 40 can be lessened. As a result, the communication system 1 can provide a more stable random access procedure.

Message 3 of NR

Message 3 of NR is transmitted by an NR-PUSCH (NR Physical Uplink Shared Channel). The NR-PUSCH is transmitted using the resource indicated by the random access response. Message 3 of NR includes an RRC connection request message. The format of the NR-PUSCH is instructed by a parameter included in the system information. The parameter determines, as the format of the NR-PUSCH, which of OFDM (Orthogonal Frequency Division Multiplexing) and DFT-s-OFDM (Discrete Fourier Transform Spread OFDM) is used, for example.

When normally receiving Message 3 of NR, the control unit 23 of the ground station 20 shifts to processing to transmit the contention resolution (Message 4). On the other hand, when being unable to normally receive Message 3 of NR, the control unit 23 again attempts reception of Message 3 of NR at least for a certain period.

Another example of the instruction of resending of Message 3 and the transmission resource includes an instruction by the NR-PDCCH for use in the instruction to resend Message 3. The NR-PDCCH is an uplink grant. The DCI (Downlink Control Information) of the NR-PDCCH instructs a resource of resending of Message 3. The terminal device 40 retransmits Message 3 based on the instruction of the uplink grant.

When reception of the contention resolution of NR has not succeeded within a certain period, the terminal device 40 regards the random access procedure as a failure and performs the processing to resend the NR-PRACH A transmission beam of the terminal device 40 for use in resending of Message 3 of NR may be different from a transmission beam of the terminal device 40 used for the first sending of Message 3. When neither the contention resolution of NR nor the instruction to resend Message 3 has been able to be received within a certain period, the terminal device 40 regards the random access procedure as a failure and performs the processing to resend the NR-PRACH. The predetermined period is set by, for example, system information.

Contention Resolution of NR (Message 4)

The contention resolution of NR is transmitted using the NR-PDSCH. The NR-PDSCH including the contention resolution is scheduled by the NR-PDCCH in which the CRC is scrambled by the TC-RNTI or the C-RNTI. The NR-PDCCH with the CRC scrambled by the TC-RNTI is placed in the CSS of the Type1-PDCCH CSS set. The NR-PDCCH may be placed in a USS (User equipment specific Search Space). The NR-PDCCH may be placed in another CSS.

When normally receiving the NR-PDSCH including the contention resolution, the terminal device 40 transmits acknowledgment (ACK) to the ground station 20. From this point onward, the terminal device 40 regards the random access procedure as a success and shifts to the connected state (RRC_CONNECTED). On the other hand, when receiving negative acknowledgment (NACK) to the NR-PDSCH from the terminal device 40, or when there is no acknowledgment, the control unit 23 of the ground station 20 resends the NR-PDSCH including the contention resolution. When being unable to receive the contention resolution (Message 4) of NR within a certain period, the terminal device 40 regards the random access procedure as a failure and performs processing to resend the random access preamble (Message 1).

(2-STEP RACH of NR in Present Embodiment)

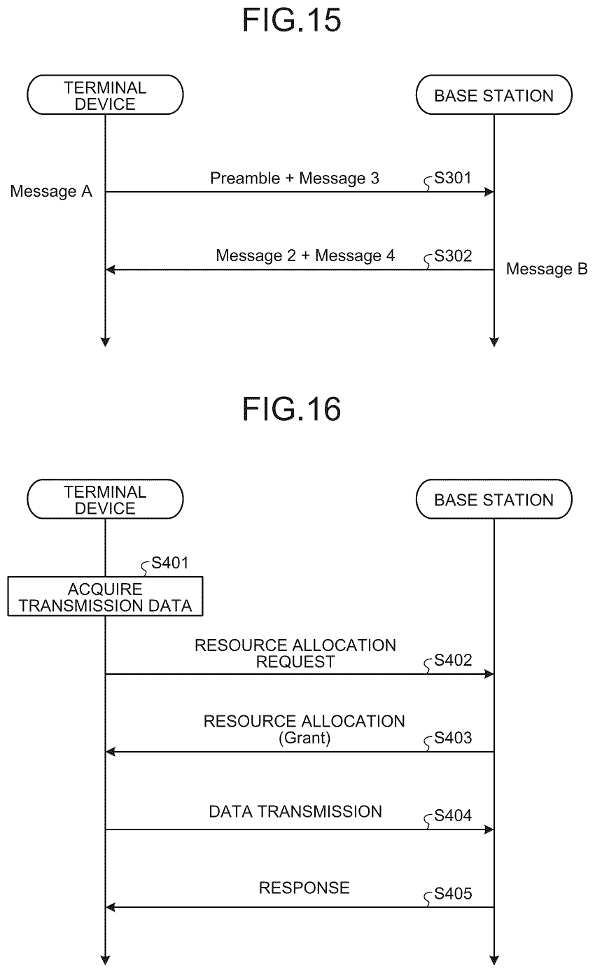

Next, an example of a 2-STEP RACH procedure (hereinafter, referred to as a two-step random access procedure) of NR will be described. FIG. 15 is a diagram illustrating the two-step random access procedure. The two-step random access procedure includes two steps of Message A (Step S301) and Message B (Step S302). As an example, Message A includes Message 1 (preamble) and Message 3 of a conventional four-step random access procedure (4-STEP RACH procedure), and Message B includes Message 2 and Message 4 of the conventional four-step random access procedure. Furthermore, as an example, Message A includes a preamble (also referred to as PRACH) and the PUSCH, and Message B includes the PDSCH.

By adopting the two-step random access procedure, the random access procedure can be completed with a lower delay as compared with the conventional four-step random access procedure.

The preamble and the PUSCH included in Message A may be set in association with each transmission resource, or may be set by an independent resource.

When the transmission resources are set in association with each other, for example, in a case where the transmission resource of the preamble is determined, the transmission resource of the PUSCH that can be unique or a plurality of candidates is determined. As an example, the time and frequency offset between the preamble of the PRACH occasion and the PUSCH occasion are defined by one value. As another example, in the time and the frequency offset between the preamble of the PRACH occasion and the PUSCH occasion, different values are set for each preamble. The value of the offset may be determined by a specification, or may be quasi-statically set by the ground station 20. As an example of the value of the time and the frequency offset, for example, the value is defined by a predetermined frequency. For example, in an unlicensed band (for example, 5 GHz band, band 45), a value of time offset may be set to 0 or a value close to 0. Accordingly, LBT (Listen Before Talk) can be omitted before transmission of the PUSCH.

On the other hand, when the transmission resource is set by the independent resource, the transmission resources of the preamble and the PUSCH may be determined in the specification, or the resource may be quasi-statically set by the ground station 20, or may be determined from another information. Examples of the other information include slot format information (for example, slot format indicator or the like), BWP (Band Width Part) information, preamble transmission resource information, a slot index, and a resource block index. When the transmission resource is set by the independent resource, the base station may be notified of the association between the preamble and the PUSCH constituting one Message A by UCI included in the payload of the PUSCH or the PUSCH, or the base station may be notified of the association by a transmission physical parameter (for example, scrambling sequence of the PUSCH, DMRS sequence and/or pattern, or transmit antenna port of PUSCH) of the PUSCH.

In a method of setting the transmission resource of the preamble and the PUSCH, the case where the transmission resources are set in association with each other and the case where the transmission resource is set by the independent resource may be switched. For example, the case where the transmission resource is set by the independent resource may be applied in a licensed band, and the case where the transmission resources are set in association with each other may be applied in the unlicensed band.

<4-3. Transmission/Reception Processing (Grant Based)>

Next, transmission (uplink) of data from the terminal device 40 to the ground station 20 will be described. Uplink data transmission is divided into “transmission/reception processing (Grant Based)” and “transmission/reception processing (Configured Grant)”. First, the “transmission/reception processing (Grant Based)” will be described.

The transmission/reception processing (Grant Based) is processing in which the terminal device 40 receives dynamic resource allocation (Grant) from the ground station 20 and transmits data. FIG. 16 is a sequence diagram illustrating an example of the transmission/reception processing (Grant Based). Hereinafter, the transmission/reception processing (Grant Based) will be described with reference to FIG. 16. The transmission/reception processing (Grant Based) described below is executed, for example, when the terminal device 40 is in the connected state (RRC_CONNECTED) with the ground station 20.

First, the acquisition unit 431 of the terminal device 40 acquires transmission data (Step S401). For example, the acquisition unit 431 acquires, as transmission data, data generated as data to be transmitted to another communication device (for example, the ground station 20) by various programs included in the terminal device 40.

When the acquisition unit 431 acquires the transmission data, the transmission unit 433 of the terminal device 40 transmits a resource allocation request to the ground station 20 (Step S402).

The reception unit 232 of the ground station 20 receives the resource allocation request from the terminal device 40. Then, the communication control unit 234 of the ground station 20 determines a resource to be allocated to the terminal device 40. Then, the transmission unit 233 of the ground station 20 transmits information on the resource allocated to the terminal device 40 to the terminal device (Step S403).

The reception unit 432 of the terminal device 40 receives the resource information from the ground station and stores the resource information in the storage unit 42. The transmission unit 433 of the terminal device 40 transmits data to the ground station 20 based on the resource information (Step S404).

The reception unit 232 of the ground station 20 acquires the data from the terminal device 40. When the reception is completed, the transmission unit 233 of the ground station 20 transmits response data (for example, acknowledgment) to the terminal device 40 (Step S405). When the transmission of the response data is completed, the ground station 20 and the terminal device 40 end the transmission/reception processing (Grant Based).

<4-4. Transmission/Reception Processing (Configured Grant)>

Next, the “transmission/reception processing (Configured Grant)” will be described.

The transmission/reception processing (Configured Grant) is processing of transmitting data from the terminal device 40 to the ground station 20 using configured grant transmission. Here, the configured grant transmission indicates that communication device does not receive dynamic resource allocation (Grant) from another communication device, and the communication device transmits using an appropriate resource from available frequency and the time resource instructed in advance from another communication device. That is, the configured grant transmission indicates that the data transmission is performed without including the grant in the DCI. The configured grant transmission is also referred to as data transmission without grant, grant-free, semi-persistent scheduling, or the like.

In the case of the configured grant transmission, the ground station 20 specifies candidates of the frequency and the time resource selectable by the terminal device 40 in advance. A main purpose of this includes power saving of the terminal device 40 and low delay communication by reducing a signaling overhead.

In the grant-based transmission/reception processing, the ground station 20 notifies the terminal device 40 of the resource used in the uplink and the sidelink. As a result, the terminal device 40 can communicate without causing resource contention with the other terminal devices 40. However, in this method, the signaling overhead due to notification occurs.

In the configured grant transmission, the processing of Step S402 and Step S403 in the example of FIG. 16 can be reduced. Thus, the configured grant transmission that does not perform resource allocation notification is considered as a promising technology candidate in power saving and low delay communication required in next-generation communication. The transmission resource in the configured grant transmission may be selected from all available bands or may be selected from the resources designated in advance from the ground station 20.

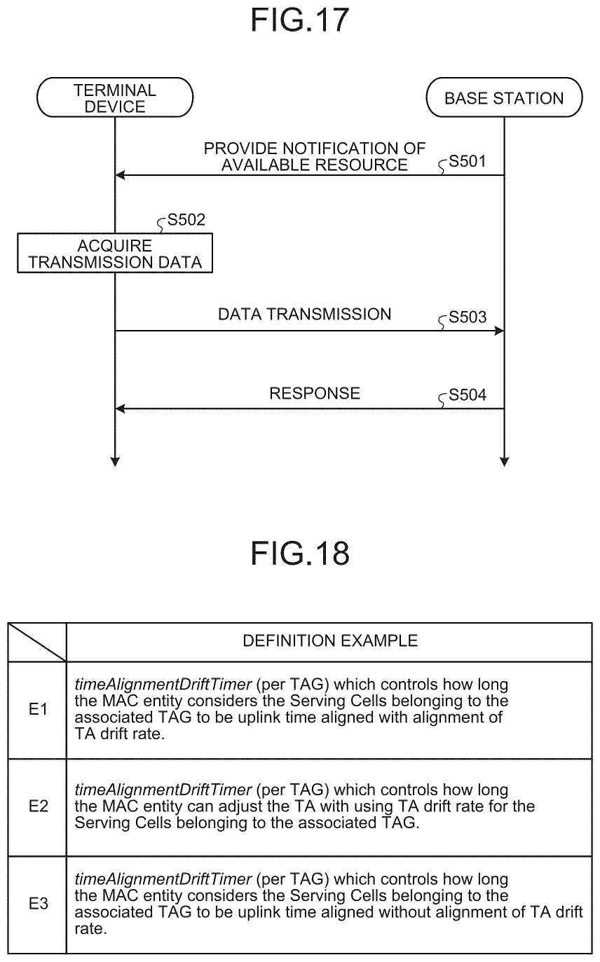

FIG. 17 is a sequence diagram illustrating an example of the transmission/reception processing (Configured Grant). Hereinafter, the transmission/reception processing (Configured Grant) will be described with reference to FIG. 17. The transmission/reception processing (Configured Grant) described below is executed, for example, when the terminal device 40 is in the connected state (RRC_CONNECTED) with the ground station 20.

When the terminal device 40 is in the connected state, the communication control unit 234 of the ground station 20 determines a resource to be allocated to the terminal device 40. Then, the transmission unit 233 of the ground station 20 transmits information on the resource allocated to the terminal device 40 to the terminal device (Step S501).

The reception unit 432 of the terminal device 40 receives the resource information from the ground station and stores the resource information in the storage unit 22. Then, the acquisition unit 431 of the terminal device acquires generated transmission data (Step S502). For example, the acquisition unit 431 acquires, as transmission data, data generated as data to be transmitted to another communication device by various programs included in the terminal device 40.

Then, the transmission unit 433 of the terminal device 40 transmits data to the ground station 20 based on the resource information (Step S503).

The reception unit 232 of the ground station 20 receives the data from the terminal device 40. When the reception is completed, the transmission unit 233 of the ground station 20 transmits response data (for example, acknowledgment) to the terminal device 40 (Step S504). When the transmission of the response data is completed, the ground station 20 and the terminal device 40 end the transmission/reception processing (Configured Grant).

### 5. PROCESSING RELATED TO TIMER RELATED TO TIMING ADVANCE

The basic operation of the communication system 1 has been described above. Next, processing related to a timer related to the timing advance will be described.

As described above, the conventional timing advance mechanism includes the timer that determines the expiration of the timing advance value. Even if the terminal device 40 continues to autonomously correct the timing advance value, if the timer expires, the terminal device 40 cannot transmit data.

Thus, in the present embodiment, the terminal device 40 and/or the base station executes processing related to the timer described below, thereby enabling the terminal device 40 to continue to transmit the uplink signal based on the autonomously corrected timing advance value.

In the following description, when a specific example is shown, there is a portion where a specific value is shown and described; however, the value does not depend on the example, and another value may be used.

In the following description, the resource indicates, for example, a frequency, a time, a resource element (including REG, CCE, CORESET), a resource block, a bandwidth part, a component carrier, a symbol, a sub-symbol, a slot, a mini-slot, a subslot, a subframe, a frame, a PRACH occasion, an occasion, a code, a multi-access physical resource, a multi-access signature, a subcarrier spacing (numerology), or the like. It is a matter of course that the resources are not limited to these examples.

The base station in the following description can be replaced with the non-ground station 30 (non-ground base station) that operates as a communication device, such as a drone, a balloon, or an airplane. Furthermore, the base station in the following description can be replaced with the ground station 20 (ground base station). That is, the technology of the present disclosure is applicable not only to communication between the non-ground base station and the terminal device but also to communication between the ground base station and the terminal device.

<5-1. Outline of Processing>

First, an outline of the processing related to a timer will be described.

<5-1-1. Autonomous Adjustment of Timing Advance Value>

First, an outline of processing as a premise of the processing related to a timer will be described. The processing as the premise is autonomous adjustment of the timing advance value.

(1) Determination of Timing Advance Value

First, the terminal device 40 receives the timing advance value and timing advance correction information from the base station. Then, the terminal device 40 determines the timing advance value used for data transmission based on the timing advance value and the timing advance correction information. For example, the terminal device 40 may directly use the timing advance value notification of which is provided from the base station as the timing advance value for data transmission, or may use the corrected timing advance value as the timing advance value for data transmission.

(2) Calculation of Correction Value of Timing Advance Value

When it is determined that the corrected timing advance value is used as the timing advance value for data transmission, the terminal device 40 calculates a correction value of the timing advance value based on the timing advance correction information. The correction value calculated here is the corrected timing advance value. The terminal device 40 transmits data based on the determined timing advance value.

<5-1-2. Outline of Processing Related to Timer>

Based on the above, an outline of the processing related to a timer will be described.

In the following description, the terminal device may be replaced with a SDAP (Service Data Protocol) entity, a PDCP (Packet Data Convergence Protocol) entity, an RLC (Radio Link Control) entity, a MAC entity, or the like.

(1) Determination of Timing Advance Value

First, the terminal device 40 determines the timing advance value used for data transmission based on the timing advance value and the timing advance correction information received from the base station.

(Notification of Timing Advance Value)

Here, the terminal device 40 may determine the timing advance value based on the random access response of the random access procedure, Message B of the two-step random access procedure, or the advance value notification of which is provided by the MAC CE.

Notification of the timing advance value may be provided by the DCI included in the PDCCH. Notification of the DCI may be provided in a DCI format notifying each terminal uniquely, or may be provided in a DCI format notifying a plurality of terminal groups. A field related to the timing advance value may be an absolute value (for example, a value from a downlink reception frame timing) of the timing advance value, or may be a difference value (for example, a difference between the timing advance value at a predetermined time and the timing advance value at the notification time) from a predetermined value.

(Timing Advance Correction Information)

Here, the timing advance correction information is information for correcting the timing advance value. In the following description, the timing advance correction information may be simply referred to as correction information. As the timing advance correction information, information indicated in A1 to A3 below can be assumed. The timing advance correction information is not limited to the following.

(A1) Information Regarding Time Variation of Timing Advance

As the timing advance correction information, information regarding time variation of the timing advance is assumed. The information regarding the time variation of the timing advance may be referred to as a timing advance (TA) drift, a timing advance drift rate, a timing drift rate, or the like, or may be referred to other than these.

(A2) Information Regarding Common Correction Time of Timing Advance

As the timing advance correction information, information regarding a common correction time of the timing advance is assumed.

(A3) Other Information Necessary for Calculation of Timing Advance

In addition, as the timing advance correction information, the position, orbit, altitude, velocity, or movement direction of a satellite, a flight path of UAV, the position information of the terminal device, the velocity of the terminal device, a movement direction of the terminal device, a distance between the satellite and the terminal device, SCS (Subcarrier Spacing), or OFDM numerology is assumed.

(Application of Timing Advance Value)

When the timing advance value notification of which is provided from the base station and the corrected timing advance value are obtained at the same time, the terminal device 40 preferentially applies the timing advance value notification of which is provided from the base station. When the corrected timing advance value is applied, the terminal device 40 may transmit feedback information indicating that the timing advance value is applied to the base station. Notification of the feedback information may be provided by, for example, UCI, MAC CE, or the like, or may be provided by means other than these.

(2) Calculation of Correction Value of Timing Advance Value

The terminal device 40 calculates a correction value of the timing advance based on the timing advance correction information. As described above, the correction value of the timing advance is the corrected timing advance value. The terminal device 40 transmits data based on the correction value of the timing advance.

(3) Processing Related to Timer

When the correction value is not calculated from the timing advance correction information, the terminal device applies the conventional timer processing. The conventional timer is, for example, a conventional TAT (Time Alignment Timer), and the conventional timer processing is, for example, processing of the conventional TAT.

On the other hand, when the correction value of the timing advance value is calculated from the timing advance correction information, the terminal device 40 executes, for example, at least one of the following processing indicated by B1 to B4.

(B1) Addition of other processing to conventional timer processing

(B2) Use of new timer different from conventional timer

(B3) Invalidation of conventional timer

(B4) Making conventional timer infinite

As a result, even when the terminal device 40 continues to update the timing advance value with the timing advance correction information, data transmission other than transmission of the first message in the random access procedure is also possible.

Although the outline of the processing related to the timer has been described above, the processing of B1 to B4 will be described below.

<5-2. Addition of Other Processing to Conventional Timer Processing>

First, addition of other processing to the conventional timer processing will be described. As described above, examples of the conventional timer processing include the conventional TAT (Time Alignment Timer) processing. Hereinafter, the conventional timer processing will be described as processing of TAT.

<5-2-1. Another Processing 1>

When the predetermined condition is satisfied, the terminal device 40 performs any of processing of starting the TAT, restarting the TAT, adjusting the value of the TAT to a predetermined value, and invalidating the TAT. Notification of the predetermined condition or the index thereof may be provided from the base station to the terminal device 40 (for example, information regarding the another timer may be included in a predetermined RRC message, and the base station may notify the terminal device 40 of the RRC message). Here, as the predetermined condition, conditions illustrated in the following (1) to (10) can be assumed. The predetermined condition may be any one of the following (1) to (10), or may be a combination of a plurality of conditions selected from the following (1) to (10). The conditions are not necessarily limited to these (1) to (10), and a condition that is determined to require another processing for the conventional timer processing similarly corresponds to a predetermined condition.
(1) Case where the terminal device 40 has a capability of performing autonomous correction of the timing advance value
(2) Case where the terminal device 40 is in the state of performing uplink transmission by applying the correction value of the timing advance value
(3) Case where the base station linked with the terminal device 40 is a mobile station
(4) Case where the terminal device 40 receives information indicating the position, track, altitude, speed, or moving direction of the base station from the base station
(5) Case where the terminal device 40 can acquire position information, speed information, or information regarding the moving direction of the terminal device.
(6) Case where the terminal device 40 executes uplink transmission by applying the correction value of the timing advance value
(7) Case where the terminal device 40 transmits data by applying the correction value of the timing advance value and then receives the acknowledgment (ACK) or information (for example, UL grant) corresponding to the acknowledgment from the base station
(8) Case where the terminal device 40 receives an explicit TAT invalidation notification from the base station
(9) Case where the number of transmission times after expiration of the TAT is less than a predetermined number of times
(10) Case where the lapse of time after the expiration of the TAT is less than a predetermined time

Here, the terminal device 40 may start the TAT when the predetermined condition is satisfied and the TAT is stopped due to expiration and the like.

When the predetermined condition is satisfied and the TAT is operating, the terminal device 40 may restart the TAT.

When the predetermined condition is satisfied and the TAT is operating, the terminal device 40 may restart the TAT after adjusting the value of the TAT. For example, when the predetermined condition is satisfied and the TAT is operating, the terminal device 40 may restart the operation of the TAT after increasing or decreasing the value of the TAT by a predetermined value. Alternatively, when the predetermined condition is satisfied and the TAT is operating, the terminal device 40 may restart the operation of the TAT after setting the value of the TAT to a predetermined value. Here, the information regarding the predetermined value may be information notification of which is provided from the base station.

<5-2-2. Another Processing 2>

When a predetermined condition is satisfied, the terminal device 40 performs processing in a case where the TAT has expired. Notification of the predetermined condition or the index thereof may be provided from the base station to the terminal device 40 (for example, information regarding the another timer may be included in a predetermined RRC message, and the base station may notify the terminal device 40 of the RRC message). Here, as the predetermined condition, at least one of conditions illustrated in the following (1) to (5) can be assumed. The conditions are not necessarily limited to these (1) to (5), and the same applies to a condition where it is determined that another processing for the conventional timer processing is necessary.
(1) Case where the terminal device 40 transmits data by applying the correction value of the timing advance value and then receives information (for example, UL grant including retransmission instruction) corresponding to a predetermined number of negative acknowledgments or acknowledgments from the base station (that is, case of data transmission failure)
(2) Case where a certain period of time has elapsed after the terminal device 40 transmits data by applying the correction value of the timing advance value (that is, case where it is assumed that data transmission has failed)
(3) Case where the TAT expires
(4) Case where the terminal device 40 receives notification of random access implementation from the base station
(5) Case where a radio link failure occurs

Here, the processing in the case where the TAT expires is, for example, transmission of the first message in the random access procedure. Examples of the first message in the random access procedure include the random access preamble (Message 1) and Message A in the two-step random access procedure.

<5-3. Use of New Timer Different from Conventional Timer>

The terminal device 40 uses a new timer different from the TAT. By using the new timer, the terminal device 40 can continue to perform the uplink transmission based on the autonomously corrected timing advance value without being limited by the conventional timer. In the following description, a new timer different from the TAT may be referred to as another timer.

<5-3-1. Data Transmission Processing Using Another Timer>

The another timer may be a timer that starts operating at a timing when the TAT expires. At this time, notification of information on the another timer may be provided from the base station to the terminal device 40 (for example, information on the another timer may be included in a predetermined RRC message, and the base station may notify the terminal device 40 of the RRC message). Then, while the another timer is operating, the terminal device 40 transmits data by applying the correction value of the timing advance. Accordingly, even when the TAT is stopped, the terminal device 40 can transmit data other than the first message in the random access procedure.

When the correction value of the timing advance is not applied, the terminal device 40 may be configured not to transmit data. When the terminal device 40 transmits data while another timer is operating, and the base station succeeds in receiving, the terminal device 40 may stop operating the another timer and start the TAT again.

As another example of the another timer, a timer that starts operating at a timing when the TAT starts or restarts may be assumed. When the terminal device 40 transmits data while the another timer is operating, and the base station succeeds in receiving, the TAT and the another timer may be started again.

The terminal device 40 may operate the another timer when the predetermined condition indicated by <5-2. Addition of another processing to conventional timer processing> is satisfied. The processing of operating the another timer can be regarded as one form of another processing described in <5-2>.

<5-3-2. Use Example of TAT and Another Timer>

When another timer is newly provided, the terminal device 40 may use the TAT and the another timer properly as follows.

(1) Operation of Only TAT

The terminal device 40 does not perform the autonomous correction of the timing advance, and operates only the TAT for a period during which the timing advance value notification of which is provided from the base station is directly applied and data is transmitted.

(2) Operation of Only Another Timer

The terminal device 40 performs the autonomous correction of the timing advance, and operates only the another timer for a period during which the timing advance value notification of which is provided from the base station is corrected and data is transmitted.

(3) Both the TAT and the Another Timer Operate

When both the TAT and the another timer are operating, the terminal device 40 may operate as in the following Examples 1 to 4.

Example 1: The terminal device 40 always autonomously corrects the timing advance while the another timer is operating.

Example 2: The terminal device 40 does not autonomously correct the timing advance while the TAT is operating.

Example 3: The terminal device 40 determines whether to autonomously correct the timing advance by its own determination regardless of an instruction of the base station.

Example 4: The terminal device 40 determines whether to autonomously correct the timing advance based on the information notification of which is provided by the base station and that is about the operation when both timers are operating.

<5-3-3. Processing for Each Timer>

The terminal device 40 may change processing between a case where only the TAT is used and a case where only the another timer is used.

(1) Case where Only TAT is Used

When only the TAT is used, the terminal device 40 operates according to operation of the conventional TAT.

(2) Case where Only the Another Timer is Used

If only the another timer is used, a type of transmittable data and/or a type of physical channel may be limited. The base station may notify the terminal device of the information regarding whether or not to implement these restrictions.

For example, when only the another timer is used, the PUSCH including data mapped to a predetermined 5QI (5G QoS Identifier) is transmitted.

For example, while only the another timer is used, only SRS/PUCCH is transmitted.

For example, while only the another timer is used, the configured grant PUSCH is not transmitted.

For example, when only the another timer is used, the terminal device 40 transmits a timing advance request that requests a timing advance command from the base station.

(3) Case where Both the TAT and the Another Timer are not Used

When both the TAT and the another timer are not used, data transmission that can be performed by the terminal device 40 is limited to, for example, only transmission of the first message of the random access procedure. As described above, the first message in the random access procedure is the random access preamble (Message 1) and Message A in the two-step random access procedure.

<5-3-4. Another Timer>

The another timer may be set for each TAG (Timing Advance Group or Time Alignment Group), or may be set for each cell or cell group different from the TAG. Furthermore, the another timer may be set for each control method of autonomous adjustment of the timing advance value. For example, the another timer may be set for each TA drift rate, or may be set for each base station (type (ground station, low earth orbiting satellite, geostationary satellite), altitude, speed) corresponding to the TA drift rate.

The base station may notify the terminal device of an addition to the value of the TAT as the another timer. For example, it is assumed that the base station provides notification of 1280 ms as the value of the TAT and provides notification of 500 ms as the addition of the another timer. At this time, the terminal device 40 determines that the value of the another timer is 1780 ms (=1280 ms+500 ms).

<5-3-5. Definition Example of Timer>

FIG. 18 is a definition example of the timer regarding timing advance.

(1) Definition Example of Another Timer

For example, the another timer may be a timer as defined in a definition example illustrated in E1 in FIG. 18. E1 in FIG. 18 is the definition example of another timer, and is shown as follows. In the following definition example, the MAC entity corresponds to the terminal device 40, and a time alignment drift timer corresponds to the another timer.

(Definition Example)

A time alignment drift timer (per TAG) that controls a period during which the MAC entity regards (or considers) that the serving cell belonging to the TAG associated is an uplink time aligned with alignment of the TA drift rate.

(2) Another Definition Example of Another Timer

The another timer may be a timer as defined in a definition example illustrated in E2 in FIG. 18. E2 in FIG. 18 is another definition example of another timer, and is shown as follows. In the following definition example, the MAC entity corresponds to the terminal device 40, and the time alignment drift timer corresponds to the another timer.

(Definition Example)

A time alignment drift timer (per TAG) that controls a period during which the MAC entity can adjust the TA by using the TA drift rate of the serving cell that belongs to the TAG associated.

(3) Specification Change Example of Definition of TAT

When the another timer is introduced, the definition of the TAT may be changed to a definition as illustrated in E3 in FIG. 18. E3 in FIG. 18 is a specification change example of the definition of the TAT in the case where the another timer is introduced, and is indicated as follows. In the following definition example, the MAC entity corresponds to the terminal device 40, and the time alignment drift timer corresponds to the TAT.

(Definition Example)

A time alignment drift timer (per TAG) that controls a period during which the MAC entity regards that the uplink time in the serving cell belonging to the associated TAG is the uplink time adjusted without alignment of the TA drift rate.

<5-4. Invalidation of Conventional Timer>

The terminal device 40 disables the processing of the TAT and switches the processing to another processing. By disabling the conventional timer, the terminal device 40 can continue to perform the uplink transmission based on the autonomously corrected timing advance value without being limited by the conventional timer. As processing examples, the following (1) to (3) can be assumed.

### (1) Processing Example 1

For example, the terminal device 40 calculates the correction value of the timing advance from the timing advance correction information. Then, the terminal device transmits data based on the correction value without performing the processing of the TAT.

### (2) Processing Example 2

The terminal device 40 disables the processing of the TAT, and transmits data by using a new timer (another timer) different from the TAT. For example, the terminal device 40 uses the another timer as a timer in a case where the correction value is used as the timing advance value. As described above, the correction value is a corrected timing advance value calculated based on the timing advance correction information.

In this case, the terminal device 40 may start or restart the another timer at the timing of receiving the timing advance command from the base station.

When the base station succeeds in receiving the data transmitted based on the correction value, and the terminal device 40 receives information corresponding to the acknowledgment (ACK) from the base station, the terminal device 40 may execute processing of restarting the another timer, increasing by a predetermined value, setting to a predetermined value, and the like.

When the another timer expires, the data transmission executable by the terminal device 40 may be limited only to the transmission of the first message in the random access procedure. As described above, the first message in the random access procedure is the random access preamble (Message 1) and Message A in the two-step random access procedure.

(3) Processing Example 3 After invalidating the TAT and transmitting the data, when the following condition is satisfied, the terminal device 40 may execute transmission of the first message in the random access procedure. As the condition, the following condition examples 1 to 3 can be assumed.

### Condition Example 1

For example, a case where the terminal device 40 receives information corresponding to the negative acknowledgment (NACK) from the base station is assumed as a condition for the terminal device 40 to execute the transmission of the first message. More specifically, a case where the DCI received after the data transmission by the terminal device 40 is the same as HARQ processing that transmitted the data last time, and NDI (New-Data Indicator) indicates retransmission may be assumed. A case where the terminal device 40 receives the negative acknowledgment (NACK) may also be assumed. In addition, a case where a predetermined timer time has elapsed after the terminal device 40 transmits data may also be assumed.

### Condition Example 2

For example, as the condition for the terminal device to execute the transmission of the first message, a case is assumed where the terminal device 40 receives a notification of implementation of transmission of the first message in the random access procedure from the base station.

### Condition Example 3

For example, a case where a new timer (another timer) different from the TAT expires is assumed as the condition for the terminal device 40 to execute the transmission of the first message.

<5-5. Making Conventional Timer Infinite>

For example, the terminal device 40 sets the value of the TAT to infinity, and executes processing different from the processing of the TAT as processing related to the timer. By making the conventional timer infinite, the terminal device 40 can continue to perform the uplink transmission based on the autonomously corrected timing advance value without causing the timer to expire.

This processing is basically equivalent to the above-described case of invalidating the processing of the TAT. However, in this processing, the TAT operates instead of being disabled. That is, this processing is different from the case of invalidation of the processing of the TAT in that the TAT is only set to infinity and is only enabled.

### (1) Processing Example 1

For example, the terminal device 40 sets the TAT to infinity. Then, the terminal device 40 calculates the correction value of the timing advance from the timing advance correction information, and transmits data based on the correction value.

### (2) Processing Example 2

The terminal device 40 sets the TAT to infinity. Then, the terminal device 40 transmits data by using a new timer (another timer) different from the TAT. For example, the terminal device 40 uses the another timer as a timer in a case where the correction value is used as the timing advance value. As described above, the correction value is a corrected timing advance value calculated based on the timing advance correction information.

In this case, the terminal device 40 may start or restart the another timer at the timing of receiving the timing advance command from the base station.

When the base station succeeds in receiving the data transmitted based on the correction value, and the terminal device 40 receives information corresponding to the acknowledgment (ACK) from the base station, the terminal device 40 may execute processing of restarting the another timer, increasing by a predetermined value, setting to a predetermined value, and the like.

When the another timer expires, the data transmission executable by the terminal device 40 may be limited only to the transmission of the first message in the random access procedure. As described above, the first message in the random access procedure is the random access preamble (Message 1) and Message A in the two-step random access procedure.

### (3) Processing Example 3

After setting the TAT to infinity and transmitting the data, when the following condition is satisfied, the terminal device 40 may execute transmission of the first message in the random access procedure. As the condition, the following condition examples 1 to 3 can be assumed.

### Condition Example 1

For example, a case where the terminal device 40 receives information corresponding to the negative acknowledgment (NACK) from the base station is assumed as a condition for the terminal device 40 to execute the transmission of the first message. More specifically, a case where the DCI received after the data transmission by the terminal device 40 is the same as HARQ processing that transmitted the data last time, and NDI (New-Data Indicator) indicates retransmission may be assumed. A case where the terminal device 40 receives the negative acknowledgment (NACK) may also be assumed. In addition, a case where a predetermined timer time has elapsed after the terminal device 40 transmits data may also be assumed.

### Condition Example 2

For example, as the condition for the terminal device to execute the transmission of the first message, a case is assumed where the terminal device 40 receives a notification of implementation of transmission of the first message in the random access procedure from the base station.

### Condition Example 3

For example, the case where a new timer (another timer) different from the TAT expires is assumed as the condition for the terminal device 40 to execute the transmission of the first message.

<5-6. Summary and Supplement>

For easy understanding, processing related to the timer of the present embodiment will be briefly described.

The processing related to the timer of the present embodiment is not limited to the following. For example, the processing related to the timer of the present embodiment may include processing of invalidating the conventional timer.

When the correction value of the timing advance is calculated from the timing advance correction information, and when the TAT is enabled and stopped (for example, Not running, expired, etc.), the terminal device switches the operation of the timer regarding the timing advance from the conventional operation to another operation.

(1) Operation in Case where Correction Value of Timing Advance is not Calculated from Timing Advance Correction Information

When the TAT is stopped (for example, Not running, expired, etc.), the terminal device 40 can only transmit the first message in the random access procedure. That is, when the TAT is stopped, the terminal device 40 does not perform data transmission other than transmission of the random access preamble and transmission of Message A in the two-step random access procedure.

(2) Operation in Case where Correction Value of Timing Advance is Calculated from Timing Advance Correction Information

Even when the TAT is stopped, if a predetermined condition is satisfied, the terminal device 40 can also perform data transmission other than transmission of the first message in the random access procedure.

As the predetermined condition, the following condition is assumed. The predetermined condition may be any one of the following cases, or may be a combination of a plurality of cases selected from the following cases.

A case where the terminal device 40 receives a notification related to permission of data transmission from the base station.

The number of transmission times after the TAT expires is less than a predetermined number of times. For example, when the predetermined number of times is set to 5, the terminal device 40 can transmit data up to four times even after the TAT expires.

A case where the lapse of time after the expiration of the TAT is less than a predetermined time.

A case where another timer for autonomous correction of the timing advance value is operating and another timer is operating (running).

A case where the terminal device 40 transmits the PUSCH including data mapped to a predetermined 5QI.

A case where the terminal device 40 transmits the SRS or the PUCCH.

A case where the terminal device 40 transmits the timing advance request.

<5-7. Other Processing>

The processing related to the timer may be different processing for each TAG (Timing Advance Group or Time Alignment Group). For example, the terminal device 40 (and the base station) determines whether or not the TAG to which the terminal device 40 belongs is a predetermined TAG. Then, the terminal device 40 executes the processing related to the timer based on the determination result.

For example, in the serving cell belonging to a pTAG (primary TAG), the terminal device 40 performs processing using the TAT, and in the serving cell belonging to an sTAG (secondary TAG), the terminal device 40 performs processing not using the TAT or processing in which another processing and another timer are added to the TAT. On the contrary, the terminal device 40 may perform the processing not using the TAT or the processing in which another processing and another timer are added to the TAT in the serving cell belonging to the pTAG, and perform the processing using the TAT in the serving cell belonging to the sTAG.

The TAG of the present embodiment may be defined as a new TAG different from the pTAG and the sTAG. It is assumed that the TAG of the present embodiment is defined as the tTAG. In this case, in the serving cell belonging to the tTAG, the terminal device 40 calculates the correction value of the timing advance from the timing advance correction information. Then, the terminal device performs processing of adding another processing to the processing of the conventional TAT, applying a timer different from the conventional TAT, disabling the processing of the TAT and switching the processing to another processing, or setting the TAT to infinity and switching to another processing.

### 6. SEQUENCE EXAMPLE

Although the processing related to the timer of the timing advance has been described above, a sequence example of the processing related to the timer performed by the communication system 1 will be described below.

<6-1. Sequence Example 1>

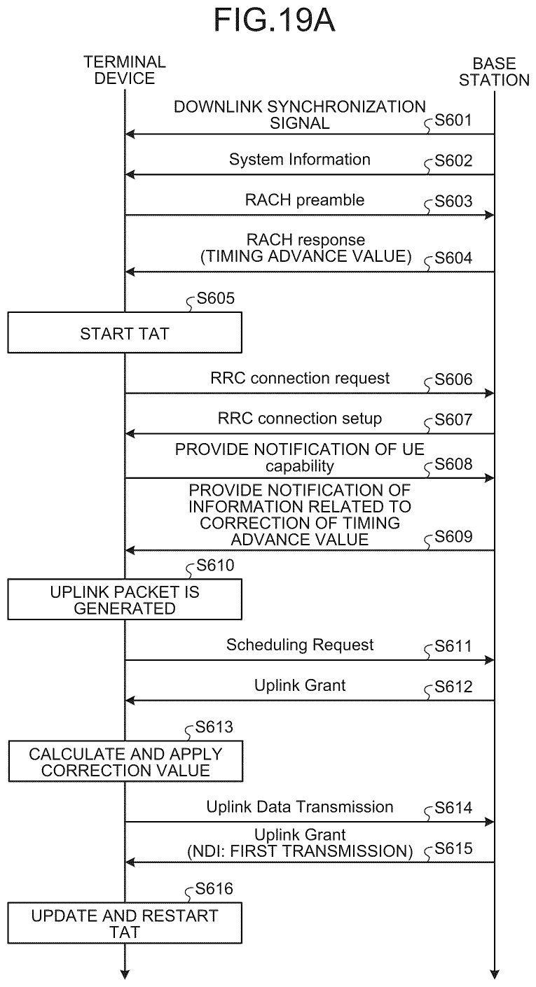

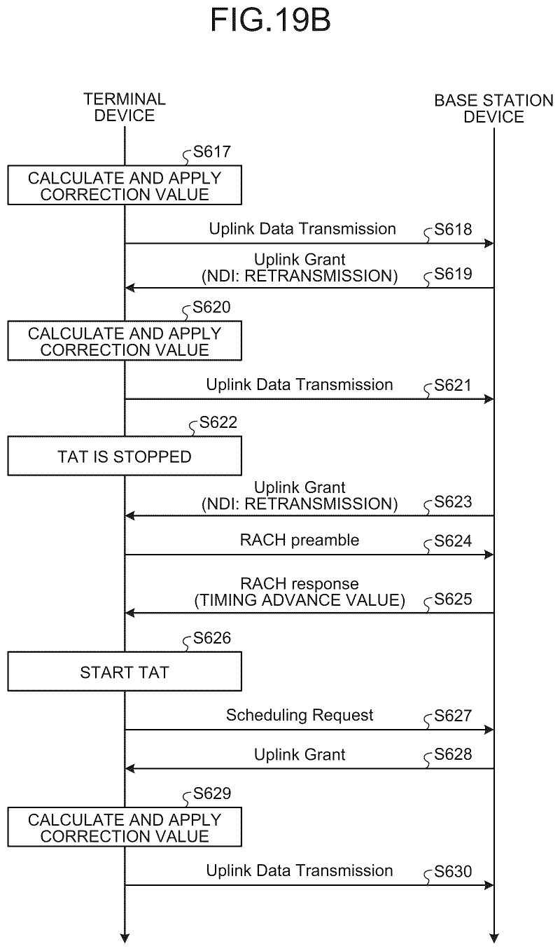

FIGS. 19A and 19B are diagrams illustrating the sequence example in the case where the terminal device 40 updates the TAT (Time Alignment Timer). In this sequence, when a predetermined condition is satisfied, the terminal device 40 performs processing different from the conventional TAT processing, such as restarting the TAT.

As illustrated in FIG. 19A, first, the base station transmits a downlink synchronization signal to surrounding devices (Step S601). The base station transmits the system information to the surrounding devices (Step S602). Then, the terminal device 40 transmits the random access preamble to the base station (Step S603). When receiving the random access preamble, the base station transmits the random access response including the timing advance value to the terminal device 40 (Step S604).

When acquiring the timing advance value, the terminal device 40 starts the TAT (Time Alignment Timer) (Step S605). Then, the terminal device 40 transmits the RRC connection request to the base station (Step S606). When receiving the RRC connection request, the base station transmits information of the RRC connection setup to the terminal device 40 (Step S607).

Thereafter, the terminal device 40 transmits its own capability information including capability information regarding correction of the timing advance value to the base station (Step S608). When the terminal device 40 has a capability of correcting the timing advance value, the base station transmits information (correction information) related to the correction of the timing advance value to the terminal device 40 (Step S609). For example, when the base station is the ground station 20, the transmission unit 233 of the ground station 20 transmits the correction information. When the base station is the non-ground station 30, the transmission unit 333 of the non-ground station 30 transmits the correction information. The reception unit 432 of the terminal device 40 receives the correction information from the ground station 20 or the non-ground station 30.

When an uplink packet is generated on the terminal device 40 side (Step S610), the terminal device 40 requests the base station to perform uplink scheduling (Step S611). When receiving the scheduling request, the base station transmits information of the uplink grant to the terminal device 40 (Step S612).

Thereafter, the terminal device 40 calculates the correction value of the timing advance value, and applies the calculated correction value as the timing advance value used for data transmission (Step S613). Then, the terminal device 40 executes data transmission based on the calculated correction value (Step S614). Thereafter, the base station transmits information of the uplink grant (NDI: first transmission) (Step S615).

The determination unit 435 of the terminal device determines whether a predetermined condition is satisfied. The predetermined condition may be the condition described in <5-2. Addition of another processing to conventional timer processing>. When the predetermined condition is satisfied, the communication control unit 434 of the terminal device 40 updates and restarts the TAT (Step S616). In order to synchronize the timer included in the terminal device 40 with the timer included in the base station, the base station side may also determine whether a predetermined condition is satisfied. For example, the determination unit 235 of the ground station 20 or the determination unit 335 of the non-ground station 30 may determine whether a predetermined condition is satisfied. Also in this case, the communication control unit 234 of the ground station 20 or the communication control unit 334 of the non-ground station 30 may update and restart the TAT.

Moving to FIG. 19B, the transmission unit 433 of the terminal device 40 calculates and applies the correction value of the timing advance value based on the correction information (Step S617). Then, the transmission unit 433 of the terminal device 40 executes the transmission of the uplink data based on the correction value (Step S618).

Here, assuming that the terminal device 40 receives the information of the uplink grant (NDI: retransmission) from the base station (Step S619), the transmission unit 433 of the terminal device 40 calculates and applies the correction value of the timing advance value again based on the correction information (Step S620). Then, the transmission unit 433 of the terminal device 40 executes the transmission of the uplink data based on the recalculated correction value (Step S621).

Here, it is assumed that the TAT is stopped (Step S622). In addition, it is assumed that the terminal device receives the information of the uplink grant (NDI: retransmission) from the base station (Step S623). In this case, when the predetermined condition is not satisfied, the terminal device 40 starts the transmission of the random access preamble again (Step S624). Then, when receiving the random access response including the timing advance value from the base station (Step S625), the terminal device 40 starts the TAT (Step S626).

Then, the terminal device 40 requests the base station to perform uplink scheduling (Step S627). When receiving the scheduling request, the base station transmits the information of the uplink grant to the terminal device 40 (Step S628). Thereafter, the terminal device 40 calculates and applies the correction value of the timing advance value (Step S629). Then, the terminal device 40 executes data transmission based on the calculated correction value (Step S630).

<6-2. Sequence Example 2>

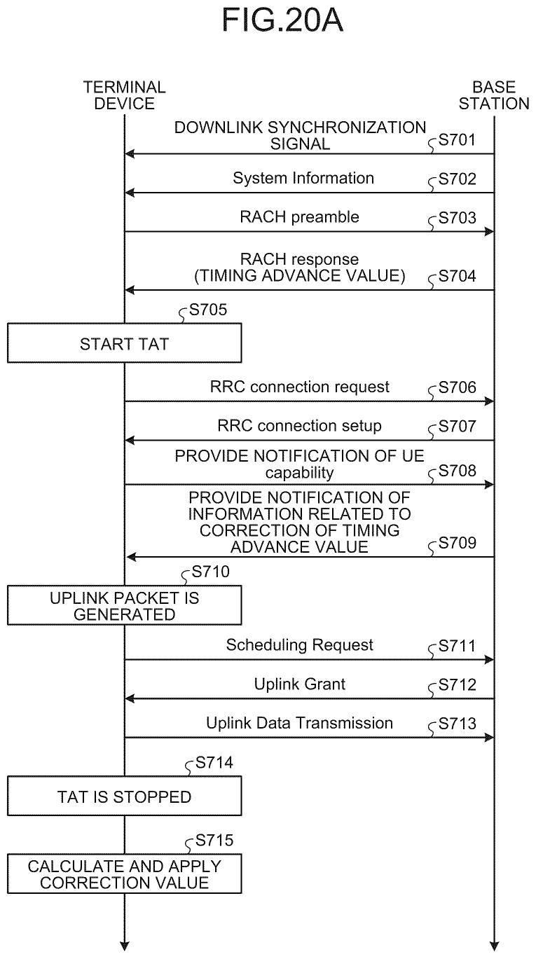

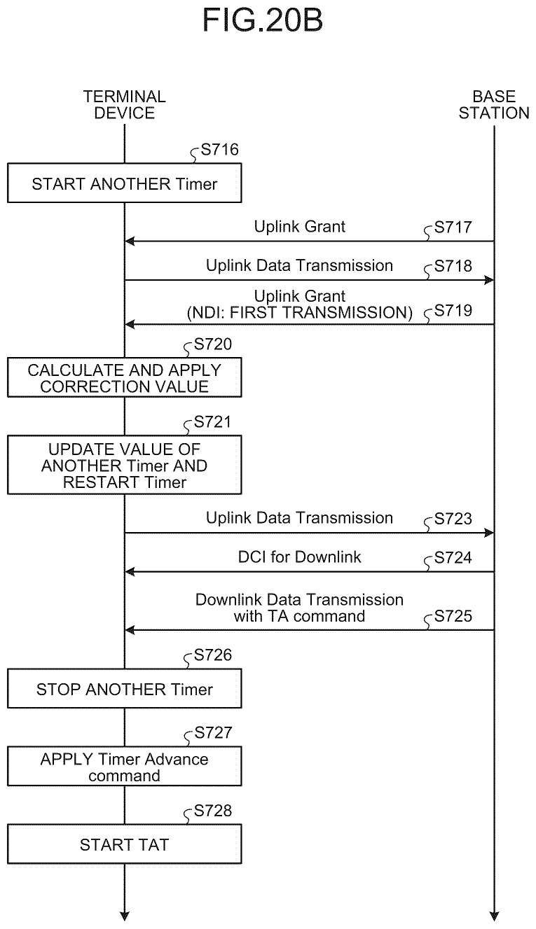

FIGS. 20A and 20B are diagrams illustrating the sequence example in a case where the terminal device 40 uses a timer different from the TAT (Time Alignment Timer). In this sequence, even when the TAT does not operate, the terminal device 40 continues data transmission using the timer different from the TAT when a predetermined condition is satisfied.

As illustrated in FIG. 20A, first, the base station transmits the downlink synchronization signal to surrounding devices (Step S701). The base station transmits the system information to the surrounding devices (Step S702). Then, the terminal device 40 transmits the random access preamble to the base station (Step S703). When receiving the random access preamble, the base station transmits the random access response including the timing advance value to the terminal device 40 (Step S704).

When acquiring the timing advance value, the terminal device 40 starts the TAT (Time Alignment Timer) (Step S705). Then, the terminal device 40 transmits the RRC connection request to the base station (Step S706). When receiving the RRC connection request, the base station transmits information of the RRC connection setup to the terminal device 40 (Step S707).

Thereafter, the terminal device 40 transmits its own capability information including the capability information regarding correction of the timing advance value to the base station (Step S708). When the terminal device 40 has the capability of correcting the timing advance value, the base station transmits the information (correction information) related to the correction of the timing advance value to the terminal device 40 (Step S709). For example, when the base station is the ground station 20, the transmission unit 233 of the ground station 20 transmits the correction information. When the base station is the non-ground station 30, the transmission unit 333 of the non-ground station 30 transmits the correction information. The reception unit 432 of the terminal device receives the correction information from the ground station 20 or the non-ground station 30.

When the uplink packet is generated on the terminal device 40 side (Step S710), the terminal device 40 requests the base station to perform uplink scheduling (Step S711). When receiving the scheduling request, the base station transmits the information of the uplink grant to the terminal device 40 (Step S712).

Thereafter, the terminal device 40 executes data transmission based on the timing advance value received in Step S704 (Step S713). Here, it is assumed that the TAT is stopped (Step S714). In this case, the terminal device 40 calculates the correction value of the timing advance value, and applies the calculated correction value as the timing advance value used for data transmission (Step S715).

Referring now to FIG. 20B, the determination unit 435 of the terminal device 40 determines whether a predetermined condition is satisfied. The predetermined condition may be the condition described in <5-2. Addition of another processing to conventional timer processing>. When the predetermined condition is satisfied, the communication control unit 434 of the terminal device 40 starts the timer different from the TAT (Step S716). In order to synchronize the timer included in the terminal device 40 with the timer included in the base station, the base station side may also determine whether a predetermined condition is satisfied. For example, the determination unit 235 of the ground station 20 or the determination unit 335 of the non-ground station 30 may determine whether a predetermined condition is satisfied. Also in this case, the communication control unit 234 of the ground station 20 or the communication control unit 334 of the non-ground station 30 may start the timer different from the TAT.

The base station transmits the information of the uplink grant to the terminal device 40 (Step S717). Then, the terminal device 40 executes data transmission based on the correction value calculated in Step S715 (Step S718).

Here, assuming that the terminal device 40 receives the information of the uplink grant (NDI: first transmission) from the base station (Step S719), the transmission unit 433 of the terminal device 40 calculates and applies the correction value of the timing advance value based on the correction information (Step S720). Then, the communication control unit 434 of the terminal device 40 restarts the another timer (Step S721). Then, the transmission unit 433 of the terminal device 40 executes the transmission of the uplink data based on the calculated correction value (Step S723).

Thereafter, it is assumed that the terminal device 40 receives the DCI from the base station (Step S724), and further receives the downlink data accompanied by the TA command (Step S725). In this case, the terminal device 40 stops the another timer (Step S726), and then applies the timing advance command (Step S727). Then, the terminal device 40 starts the TAT (Step S728).

### 7. SPECIFICATION CHANGE EXAMPLE

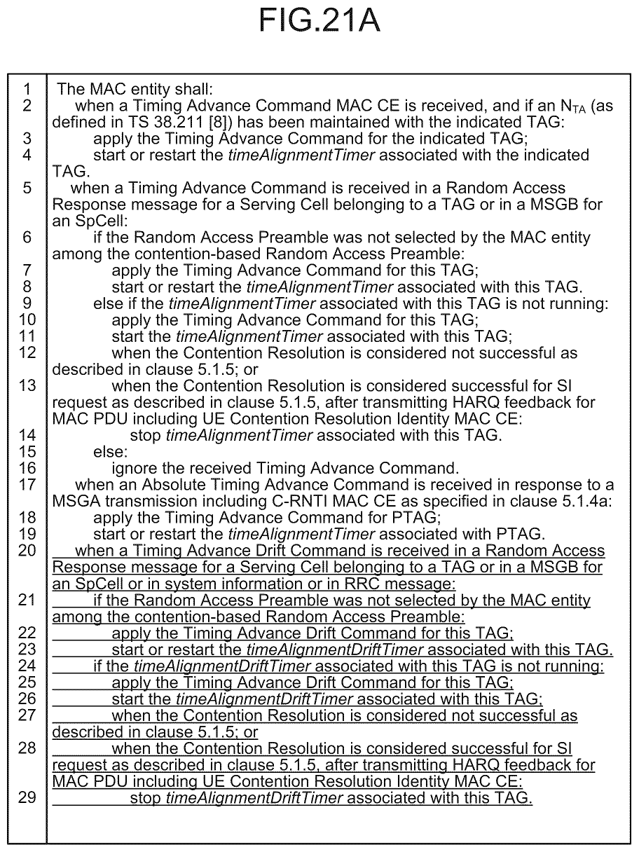

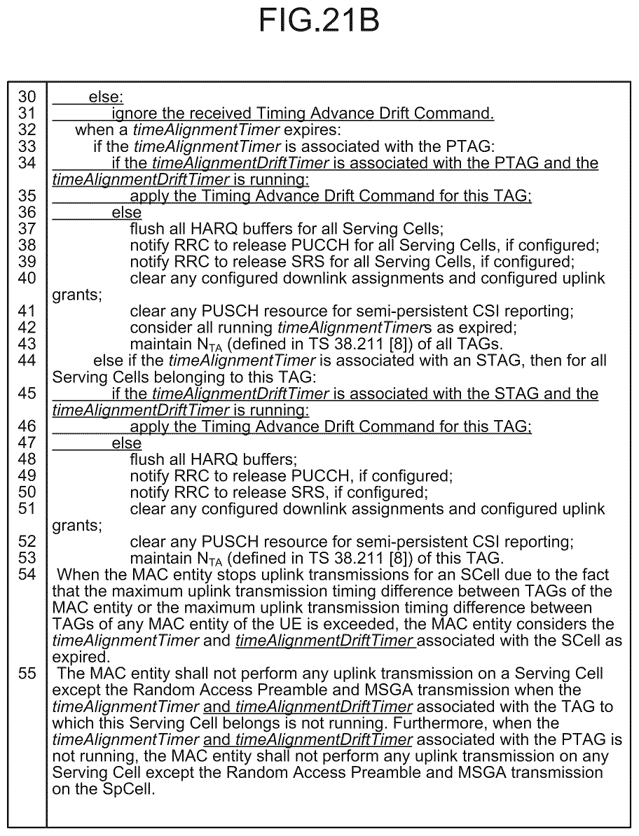

FIGS. 21A and 21B are the specification change example regarding the timing advance. Specifically, FIGS. 21A and 21B are obtained by modifying a partial description of TS 38.321 which is a technical specification of 3GPP according to the present embodiment. The underlined portions in the drawing are the changed portions. The contents illustrated in FIGS. 21A and 21B are as follows.

(Specification Change Example)

The MAC entity (terminal device 40) performs the following.

When the MAC CE for sending the TA command “Timing Advance Command MAC CE” is received, in a case where N T A is maintained by the TAG indicated (with the MAC CE), the MAC entity (terminal device 40) applies the TA command for the TAG indicated (with the MAC CE) and starts or restarts the TAT associated with the TAG indicated (with the MAC CE).

The MAC entity (terminal device 40) performs the following.

When the TA command is received in a random access response message for the serving cell belonging to a certain TAG or an MSGB (Message B, second message of 2 Step RACH) for a SpCell (special cell (PCell or PSCell)), if a previously transmitted random access preamble is not selected by the MAC entity (terminal device 40) from contention-based random access preambles, the MAC entity (terminal device 40) applies the TA command for this TAG and starts or restarts the TAT associated with this TAG.

When the TA command is received in the random access response message for the serving cell belonging to a certain TAG or the MSGB (Message B, second message of 2 Step RACH) for the SpCell (special cell (PCell or PSCell)), if the previously transmitted random access preamble is selected by the MAC entity (terminal device 40) from the contention-based random access preambles, and if the TAT associated with this TAG does not operate, the MAC entity (terminal device 40) applies the TA command for this TAG and starts the TAT associated with this TAG. In addition, when contention resolution is not successful, or when contention resolution succeeds for an SI (System Information) request after transmitting HARQ feedback for a MAC PDU including a UE contention resolution identity MAC CE, the TAT associated with this TAG is stopped.

When the TA command is received in the random access response message for the serving cell belonging to a certain TAG or the MSGB (Message B, second message of 2 Step RACH) for the SpCell (special cell (PCell or PSCell)), if the previously transmitted random access preamble is selected by the MAC entity (terminal device 40) from the contention-based random access preambles, and if the TAT associated with this TAG is operating, the received TA command is ignored.

When an absolute TA command is received as a response to an MSGA transmission including a C-RNTI MAC CE, the MAC entity (terminal device 40) applies its TA command for the PTAG (Primary TAG) and starts or restarts the TAT associated with the PTAG (Primary TAG).

When the timing advance drift command is received in the random access response message for the serving cell belonging to a certain TAG, the MSGB for the SpCell, the system information, or the RRC message, if the previously transmitted random access preamble is not selected by the MAC entity (terminal device 40) from the contention-based random access preambles, the MAC entity (terminal device 40) applies the timing advance drift command for this TAG and starts or restarts the time alignment drift timer associated with this TAG.

When the timing advance drift command is received in the random access response message for the serving cell belonging to a certain TAG, the MSGB for the SpCell, the system information, or the RRC message, if the time alignment drift timer associated with this TAG does not operate, the MAC entity (terminal device 40) applies the timing advance drift command for this TAG and starts or restarts the time alignment drift timer associated with this TAG. In addition, when contention resolution is not successful, or when contention resolution succeeds for an SI (System Information) request after transmitting HARQ feedback for a MAC PDU including a UE contention resolution identity MAC CE, the time alignment drift timer associated with this TAG is stopped.

When the timing advance drift command is received in the random access response message for the serving cell belonging to a certain TAG, the MSGB for the SpCell, the system information, or the RRC message, if the previously transmitted random access preamble is selected by the MAC entity (terminal device 40) from the contention-based random access preambles, and if the time alignment drift timer associated with this TAG is operating, the received timing advance drift command is ignored.

When the TAT (time alignment timer) expires, if the TAT is associated with the PTAG, and if the time alignment drift timer is also associated with the PTAG and the time alignment drift timer is operating, the MAC entity (terminal device 40) applies a timing advance drift command for this TAG (PTAG). Otherwise, the MAC entity (terminal device 40) flushes HARQ buffers of all serving cells, notifies the RRC to release the PUCCH of all serving cells if setting is performed, notifies the RRC to release the SRS of all serving cells if setting is performed, clears all configured downlink assignments and configured uplink grants, clears all PUCCH resources for semi-persistent CSI reporting, recognizes that all time alignment timers have expired, and maintains the values of N T A of all TAGs.

When the TAT (time alignment timer) expires, if the TAT is associated with a STAG, and if the time alignment drift timer is associated with the STAG and the time alignment drift timer is operating, the MAC entity (terminal device 40) applies the timing advance drift command for this TAG (STAG). Otherwise, the MAC entity (terminal device 40) flushes the HARQ buffers of all serving cells belonging to the TAG, notifies the RRC to release the PUCCH of all serving cells if setting is performed, notifies the RRC to release the SRS of all serving cells if setting is performed, clears all configured downlink assignments and configured uplink grants, clears all PUCCH resources for semi-persistent CSI reporting, and maintains the values of N T A of all TAGs. When the MAC entity (terminal device 40) stops the uplink transmission of a certain SCell due to the fact that a difference in the uplink transmission timing between the plurality of TAGs of one or the plurality of MAC entities in the terminal device 40 exceeds the maximum value, the MAC entity (terminal device 40) recognizes (considers) that both the time alignment timer and the time alignment drift timer associated with this SCell have expired.

When both the time alignment timer and the time alignment drift timer associated with the TAG to which a serving cell belongs do not operate, the MAC entity (terminal device 40) does not perform uplink transmission other than the random access preamble and MSGA in this serving cell. Furthermore, when both the time alignment timer and the time alignment drift timer associated with the PTAG do not operate, the MAC entity (terminal device 40) does not perform the uplink transmission in all serving cells except for the random access preamble and the MSGA transmission in the SpCell.

### 8. MODIFICATION

The above embodiment is an example, and various modifications and applications are possible.

For example, in the above embodiment, the terminal device 40 communicates with the ground station 20 via the non-ground station 30; however, the terminal device may communicate with the ground station 20 via the ground station (ground base station). The non-ground station 30 is not limited to a relay station, and the function as the base station may be directly provided to the terminal device 40.

The control device that controls the management device 10, the ground station 20, the non-ground station 30, and the terminal device 40 of the present embodiment may be realized by a dedicated computer system or a general-purpose computer system.

For example, a communication program for executing the above-described operation is stored and distributed in a computer-readable recording medium such as an optical disk, a semiconductor memory, a magnetic tape, or a flexible disk. Then, for example, the program is installed in a computer, and the above-described processing is executed to configure a control device. At this time, the control device may be a device (for example, a personal computer) outside the management device 10, the ground station 20, the non-ground station 30, and the terminal device 40. Furthermore, the control device may be a device (for example, the control unit 13, the control unit 23, the control unit 33, or the control unit 43) inside the management device 10, the ground station 20, the non-ground station 30, and the terminal device 40.

The communication program may be stored in a disk device included in a server device on a network such as the Internet so that the communication program can be downloaded to a computer. The above-described functions may be achieved by cooperation of an OS (Operating System) and application software. In this case, a portion other than the OS may be stored in a medium and distributed, or may be stored in a server device and downloaded to a computer.

Among each processing described in the above embodiment, all or a part of the processing described as being performed automatically can be performed manually, or all or a part of the processing described as being performed manually can be performed automatically by a known method. In addition, the processing procedures, specific names, and information including various data and parameters illustrated in the above specifications or drawings can be changed in any manner unless otherwise specified. For example, various types of information illustrated in the respective drawings are not limited to the information illustrated.

The components of each device illustrated in the drawings are functionally conceptual and are not necessarily physically configured as illustrated in the drawings. In other words, the specific configuration of dispersion/integration of each device is not limited to the illustrated configuration. Therefore, all or a part of each device may be dispersed or integrated functionally or physically in an optional unit in accordance with various types of loads or operating conditions.

The above-described embodiments can be appropriately combined within a range implementable without contradiction of processes. The order of each step illustrated in the flowchart of the above embodiment can be appropriately changed.

For example, the present embodiment may be also implemented as all the components configuring the apparatus or the system such as a processor as a system LSI (Large Scale Integration) or the like, a module using a plurality of processors and the like, a unit using a plurality of modules and the like, and a set acquired by adding another function to the unit (in other words, a part of the configuration of the apparatus).

In the present embodiment, a system represents a set of a plurality of constituent elements (an apparatus, a module (component), and the like), and all the constituent elements do not need to be disposed in a same casing. Thus, a plurality of apparatuses that are housed in separate casings and are connected through a network and one apparatus in which a plurality of modules are housed in one casing are systems.

For example, the present embodiment may take a configuration of cloud computing in which one function is divided and processed cooperatively by a plurality of apparatuses through a network.

### 9. CONCLUSION

As described above, according to an embodiment of the present disclosure, the terminal device 40 receives the timing advance value used for adjusting the timing of uplink transmission and the timing advance correction information for correcting the timing advance value. Then, when the predetermined condition regarding correction of the timing advance value is satisfied, the terminal device executes uplink transmission other than transmission of the first message in the random access procedure based on the corrected timing advance value even when the TAT (Time Alignment Timer) does not operate.

As a result, the terminal device 40 can continue to perform the uplink transmission based on the corrected timing advance value even after the timer expires. That is, the terminal device can continue to perform transmission based on the autonomously corrected timing advance value even after the timer expires, so that high communication performance (for example, high connection stability) can be achieved.

The embodiments of the present disclosure have been described above, the technical scope of the present disclosure is not limited to the above embodiments as they are, and various changes can be made without departing from the gist of the present disclosure. Moreover, the components over different embodiments and modifications may be suitably combined.

The effects in each embodiment described in the present specification are merely examples and are not limited, and other effects may be present.

The present technology may also be configured as below.

(1)

A communication device comprising:

a reception unit that receives a timing advance value used for adjusting timing of uplink transmission and correction information for correcting the timing advance value;

a determination unit that determines whether or not a predetermined condition regarding application of a correction value that is the timing advance value corrected based on the correction information is satisfied; and

a transmission unit that performs, when the predetermined condition is satisfied, uplink transmission other than transmission of a first message in a random access procedure based on the correction value even when a TAT (Time Alignment Timer) that starts in response to reception of the timing advance value does not operate.

(2)

The communication device according to (1), wherein

in at least one of a case where the communication device has a capability of performing autonomous correction of the timing advance value, and

a case where the communication device is in a state of performing uplink transmission by applying the correction value,

the determination unit

determines that the predetermined condition is satisfied.

(3)

The communication device according to (1) or (2), wherein

the determination unit determines that the predetermined condition is satisfied when the communication device receives an explicit invalidation notification of the TAT from a base station.

(4)

The communication device according to any one of (1) to (3), wherein

in at least one of a case where a base station linked with the communication device is a mobile station, and

a case where information indicating the position, track, altitude, speed, or moving direction of the base station is received,

the determination unit

determines that the predetermined condition is satisfied.

(5)

The communication device according to (4), wherein

in at least one of a case where the uplink transmission is executed by applying the correction value,

a case where data is transmitted by applying the correction value and then acknowledgment or information corresponding to the acknowledgment is received from the base station, and

a case where a certain period of time has elapsed after data is transmitted by applying the correction value,

the determination unit

determines that the predetermined condition is satisfied.

(6)

The communication device according to any one of (1) to (5), wherein

in at least one of a case where the number of transmission times after expiration of the TAT is less than a predetermined number of times, and

a case where the lapse of time after the expiration of the TAT is less than a predetermined time,

the determination unit

determines that the predetermined condition is satisfied.

(7)

The communication device according to any one of (1) to (6), wherein

the determination unit determines that the predetermined condition is satisfied when a TAG (Time Alignment Group) to which the communication device belongs is a predetermined TAG.

(8)

The communication device according to any one of (1) to (7), wherein

when the predetermined condition is satisfied, the transmission unit performs uplink transmission other than transmission of the first message in the random access procedure based on an operation of another timer related to application of the correction value even when the TAT does not operate.

(9)

The communication device according to any one of (1) to (7), wherein

when the predetermined condition is satisfied, the transmission unit executes predetermined processing related to the TAT and performs uplink transmission other than transmission of the first message in the random access procedure even when the TAT does not operate.

(10)

The communication device according to (9), wherein

the predetermined processing is start or restart of operation of the TAT.

(11)

The communication device according to (9), wherein

the predetermined processing is restart of the operation of the TAT after adjusting a value of the TAT.

(12)

The communication device according to (9), wherein

the predetermined processing is invalidation of a value of the TAT.

(13)

The communication device according to (9), wherein

the predetermined processing is to make a value of the TAT infinite.

(14)

The communication device according to any one of (1) to (13), wherein

uplink transmission other than transmission of the first message in the random access procedure includes at least one of transmission of a PUSCH including data mapped to a predetermined 5QI and transmission of an SRS/PUCCH.

(15)

The communication device according to any one of (1) to (14), wherein

the transmission unit transmits the first message in the random access procedure to a base station when uplink transmission based on the correction value has failed.

(16)

The communication device according to any one of (1) to (15), wherein

the transmission unit transmits the first message in the random access procedure to a base station when transmission of the first message in the random access procedure is requested from the base station.

(17)

The communication device according to any one of (1) to (16), wherein

the first message in the random access procedure is a random access preamble and Message A in a two-step random access procedure.

(18)

A communication device comprising:

a transmission unit that transmits a timing advance value used for adjusting a timing of uplink transmission of another communication device that performs the uplink transmission and correction information for the another communication device to correct the timing advance value;

a decision unit that determines whether or not a predetermined condition regarding application of a correction value that is the timing advance value corrected based on the correction information is satisfied; and

a reception unit that receives, when the predetermined condition is satisfied, an uplink transmission signal that is an uplink transmission signal by the another communication device and is other than a first message in a random access procedure even when the another communication device does not operate a TAT (Time Alignment Timer) that starts in response to reception of the timing advance value.

(19)

A communication method comprising:

receiving a timing advance value used for adjusting timing of uplink transmission and correction information for correcting the timing advance value;

determining whether or not a predetermined condition regarding application of a correction value that is the timing advance value corrected based on the correction information is satisfied; and

when the predetermined condition is satisfied, performing uplink transmission other than transmission of a first message in a random access procedure based on the correction value even when a TAT (Time Alignment Timer) that starts in response to reception of the timing advance value does not operate.

(20)

A communication method comprising:

transmitting a timing advance value used for adjusting a timing of uplink transmission of another communication device that performs the uplink transmission and correction information for the another communication device to correct the timing advance value;

determining whether or not a predetermined condition regarding application of a correction value that is the timing advance value corrected based on the correction information is satisfied; and

when the predetermined condition is satisfied, receiving an uplink transmission signal that is an uplink transmission signal by the another communication device and is other than a first message in a random access procedure even when the another communication device does not operate a TAT (Time Alignment Timer) that starts in response to reception of the timing advance value.

### REFERENCE SIGNS LIST

1 COMMUNICATION SYSTEM
10 MANAGEMENT DEVICE
20 GROUND STATION
30 NON-GROUND STATION
40 TERMINAL DEVICE
11 COMMUNICATION UNIT
21, 31, 41 WIRELESS COMMUNICATION UNIT
12, 22, 32, 42 STORAGE UNIT
13, 23, 33, 43 CONTROL UNIT
211, 311, 411 RECEPTION PROCESSING UNIT
212, 312, 412 TRANSMISSION PROCESSING UNIT
213, 313, 413 ANTENNA
231, 331, 431 ACQUISITION UNIT
232, 332, 432 RECEPTION UNIT
233, 333, 433 TRANSMISSION UNIT
234, 334, 434 COMMUNICATION CONTROL UNIT
235, 335, 435 DETERMINATION UNIT

1. A communication device comprising:
a reception unit that receives a timing advance value used for adjusting timing of uplink transmission and correction information for correcting the timing advance value;
a determination unit that determines whether or not a predetermined condition regarding application of a correction value that is the timing advance value corrected based on the correction information is satisfied; and
a transmission unit that performs, when the predetermined condition is satisfied, uplink transmission other than transmission of a first message in a random access procedure based on the correction value even when a TAT (Time Alignment Timer) that starts in response to reception of the timing advance value does not operate.

2. The communication device according to claim 1, wherein
in at least one of a case where the communication device has a capability of performing autonomous correction of the timing advance value, and
a case where the communication device is in a state of performing uplink transmission by applying the correction value,
the determination unit
determines that the predetermined condition is satisfied.

3. The communication device according to claim 1, wherein
the determination unit determines that the predetermined condition is satisfied when the communication device receives an explicit invalidation notification of the TAT from a base station.

4. The communication device according to claim 1, wherein
in at least one of a case where a base station linked with the communication device is a mobile station, and
a case where information indicating the position, track, altitude, speed, or moving direction of the base station is received,
the determination unit
determines that the predetermined condition is satisfied.

5. The communication device according to claim 4, wherein
in at least one of a case where the uplink transmission is executed by applying the correction value,
a case where data is transmitted by applying the correction value and then acknowledgment or information corresponding to the acknowledgment is received from the base station, and
a case where a certain period of time has elapsed after data is transmitted by applying the correction value,
the determination unit
determines that the predetermined condition is satisfied.

6. The communication device according to claim 1, wherein
in at least one of a case where the number of transmission times after expiration of the TAT is less than a predetermined number of times, and
a case where the lapse of time after the expiration of the TAT is less than a predetermined time,
the determination unit
determines that the predetermined condition is satisfied.

7. The communication device according to claim 1, wherein
the determination unit determines that the predetermined condition is satisfied when a TAG (Time Alignment Group) to which the communication device belongs is a predetermined TAG.

8. The communication device according to claim 1, wherein
when the predetermined condition is satisfied, the transmission unit performs uplink transmission other than transmission of the first message in the random access procedure based on an operation of another timer related to application of the correction value even when the TAT does not operate.

9. The communication device according to claim 1, wherein
when the predetermined condition is satisfied, the transmission unit executes predetermined processing related to the TAT and performs uplink transmission other than transmission of the first message in the random access procedure even when the TAT does not operate.

10. The communication device according to claim 9, wherein
the predetermined processing is start or restart of operation of the TAT.

11. The communication device according to claim 9, wherein
the predetermined processing is restart of the operation of the TAT after adjusting a value of the TAT.

12. The communication device according to claim 9, wherein
the predetermined processing is invalidation of a value of the TAT.

13. The communication device according to claim 9, wherein
the predetermined processing is to make a value of the TAT infinite.

14. The communication device according to claim 1, wherein
uplink transmission other than transmission of the first message in the random access procedure includes at least one of transmission of a PUSCH including data mapped to a predetermined 5QI and transmission of an SRS/PUCCH.

15. The communication device according to claim 1, wherein
the transmission unit transmits the first message in the random access procedure to a base station when uplink transmission based on the correction value has failed.

16. The communication device according to claim 1, wherein
the transmission unit transmits the first message in the random access procedure to a base station when transmission of the first message in the random access procedure is requested from the base station.

17. The communication device according to claim 1, wherein
the first message in the random access procedure is a random access preamble and Message A in a two-step random access procedure.

18. A communication device comprising:
a transmission unit that transmits a timing advance value used for adjusting a timing of uplink transmission of another communication device that performs the uplink transmission and correction information for the another communication device to correct the timing advance value;
a decision unit that determines whether or not a predetermined condition regarding application of a correction value that is the timing advance value corrected based on the correction information is satisfied; and
a reception unit that receives, when the predetermined condition is satisfied, an uplink transmission signal that is an uplink transmission signal by the another communication device and is other than a first message in a random access procedure even when the another communication device does not operate a TAT (Time Alignment Timer) that starts in response to reception of the timing advance value.

19. A communication method comprising:
receiving a timing advance value used for adjusting timing of uplink transmission and correction information for correcting the timing advance value;
determining whether or not a predetermined condition regarding application of a correction value that is the timing advance value corrected based on the correction information is satisfied; and
when the predetermined condition is satisfied, performing uplink transmission other than transmission of a first message in a random access procedure based on the correction value even when a TAT (Time Alignment Timer) that starts in response to reception of the timing advance value does not operate.

20. A communication method comprising:
transmitting a timing advance value used for adjusting a timing of uplink transmission of another communication device that performs the uplink transmission and correction information for the another communication device to correct the timing advance value;
determining whether or not a predetermined condition regarding application of a correction value that is the timing advance value corrected based on the correction information is satisfied; and
when the predetermined condition is satisfied, receiving an uplink transmission signal that is an uplink transmission signal by the another communication device and is other than a first message in a random access procedure even when the another communication device does not operate a TAT (Time Alignment Timer) that starts in response to reception of the timing advance value.
